(19) United States
(12) Patent Application Publication
(10) Pub. No.: US 2012/0088548 A1
(43) Pub. Date: Apr. 12, 2012

(54) MOBILE TERMINAL, DISPLAY DEVICE AND CONTROLLING METHOD THEREOF

(76) Inventors: Chanphill Yun, Seoul (KR); Eungkyu Song, Seoul (KR)

(21) Appl. No.: 13/010,618

(22) Filed: Jan. 20, 2011

(30) Foreign Application Priority Data
Oct. 6, 2010 (KR) PCT/KR2010/006819

(51) Int. Cl. G09G 5/00; H04W 88/02

(52) U.S. Cl. 455/557

(57) ABSTRACT

A mobile terminal including a first display unit configured to display at least one of a first home screen image and a second home screen image as an output home screen image; an interface unit configured to be connected to an external computer display device having a second display unit; and controller configured to generate a monitor window including a copy of the output home screen image displayed on the first display unit of the mobile terminal and to control the external computer display device to simultaneously display the generated monitor window on the second display unit of the second display unit.

Pursuant to 35 U.S.C. §119(a), this application claims the benefit of earlier filing date and right of priority to International patent Application No. PCT/KR2010/006819, filed on Oct. 6, 2010, the contents of which are hereby incorporated by reference herein in their entirety.

### BACKGROUND OF THE INVENTION

1. Field of the Invention

The present invention relates to a mobile terminal, and more particularly, to a mobile terminal, display device and controlling method thereof. Although the present invention is suitable for a wide scope of applications, it is particularly suitable for enabling data communications between a mobile terminal and a display device when the mobile terminal and the display device are connected together.

2. Discussion of the Related Art

A mobile terminal is a device which may be configured to perform various functions. Examples of such functions include data and voice communications, capturing images and video via a camera, recording audio, playing music files and outputting music via a speaker system, and displaying images and video on a display. Some terminals include additional functionality which supports game playing, while other terminals are also configured as multimedia players. More recently, mobile terminals have been configured to receive broadcast and multicast signals which permit viewing of contents, such as videos and television programs.

Further, the mobile terminal can be connected to an external computer display device such as a notebook computer, a tablet computer, a personal computer, a television set and the like by wire or wirelessly and can then perform data communications in-between. However, the data communications between the mobile terminal and display device are limited in nature and often inconvenient to the user.

### SUMMARY OF THE INVENTION

Accordingly, one object of the present invention is to provide a mobile terminal, display device and controlling method thereof that substantially obviate one or more problems due to limitations and disadvantages of the related art.

Another object of the present invention is to provide a mobile terminal, display device and controlling method thereof, by which when the data communications are performed between the mobile terminal and the display device, information on the data communications in-between can be displayed on the mobile terminal and/or the display device in further consideration of terminal user's convenience.

To achieve these objects and other advantages and in accordance with the purpose of the invention, as embodied and broadly described herein, the present invention provides in one aspect a mobile terminal including a first display unit configured to display at least one of a first home screen image and a second home screen image as an output home screen image; an interface unit configured to be connected to an external computer display device having a second display unit; and controller configured to generate a monitor window including a copy of the output home screen image displayed on the first display unit of the mobile terminal and to control the external computer display device to simultaneously display the generated monitor window on the second display unit of the second display unit. The present invention also provides a corresponding method of controlling the mobile terminal.

In another aspect, the present invention provides a computer display device including an interface unit configured to be connected to a mobile terminal having a first display unit configured to display at least one of a first home screen image and a second home screen image as an output home screen image on the first display unit; a second display unit; and a controller configured to generate a monitor window including a copy of the output home screen image displayed on the first display unit and to control the second display unit to simultaneously display the generated monitor window on the second display unit. The present invention also provides a corresponding method of controlling the computer display device.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. The above and other aspects, features, and advantages of the present invention will become more apparent upon consideration of the following description of preferred embodiments, taken in conjunction with the accompanying drawing figures. In the drawings:

FIG. 1 is a block diagram of a mobile terminal according to one embodiment of the present invention;

FIG. 2 is a block diagram of a display device according to one embodiment of the present invention;

FIG. 3 is a diagram of a mobile terminal and a display device connected to each other to implement an embodiment of the present invention;

FIG. 4 is a flowchart illustrating an embodiment of the present invention;

FIG. 5 is a diagram of home screen images displayable on a first display unit of a mobile terminal according to an embodiment of the present invention;

FIG. 6 is a front diagram of the mobile terminal including the first display unit having the home screen images shown in FIG. 5 displayed thereon;

FIGS. 7 to 12 are diagrams of screen configurations of the mobile terminal and the display unit of the display device according to an embodiment of the present invention;

FIGS. 13 to 15 are diagrams of screen configurations of the mobile terminal and the display unit of the display device according to an embodiment of the present invention;

FIGS. 16 and 17 are diagrams of screen configurations of the mobile terminal and the display unit of the display device according to an embodiment of the present invention;

FIG. 18 is a diagram of screen configurations of the mobile terminal and the display unit of the display device according to an embodiment of the present invention;

FIG. 19 is a front diagram of screen configurations of the mobile terminal according to an embodiment of the present invention;

FIG. 20 is a diagram of screen configurations of the display unit of the display device according to an embodiment of the present invention;

FIG. 21 is a diagram of screen configurations of the mobile terminal and the display unit of the display device according to an embodiment of the present invention;

FIGS. 22 to 24 are diagrams of screen configurations of the mobile terminal and the display unit of the display device according to an embodiment of the present invention;

FIG. 25 is a diagram of screen configurations of the display unit of the display device according to an embodiment of the present invention;

FIGS. 26 and 27 are diagrams of screen configurations of the mobile terminal and the display unit of the display device according to an embodiment of the present invention;

FIG. 28 is a diagram of screen configurations of the display unit of the display device according to an embodiment of the present invention;

FIG. 29 is a diagram of screen configurations of the mobile terminal and the display unit of the display device according to an embodiment of the present invention; and

FIG. 30 is a diagram of screen configurations of the display unit of the display device according to an embodiment of the present invention.

### DETAILED DESCRIPTION OF THE INVENTION

In the following detailed description, reference is made to the accompanying drawing figures which form a part hereof, and which show by way of illustration specific embodiments of the invention. It is to be understood by those of ordinary skill in this technological field that other embodiments may be utilized, and structural, electrical, as well as procedural changes may be made without departing from the scope of the present invention. Wherever possible, the same reference numbers will be used throughout the drawings to refer to the same or similar parts.

As used herein, the suffixes ‘module’, ‘unit’ and ‘part’ are used for elements in order to facilitate the disclosure only. Therefore, significant meanings or roles are not given to the suffixes themselves and it is understood that the ‘module’, ‘unit’ and ‘part’ can be used together or interchangeably.

The present invention can be applicable to a various types of mobile terminals. Examples of such terminals include mobile phones, user equipments, smart phones, digital broadcast receivers, personal digital assistants, portable multimedia players (PMP), navigators and the like.

However, by way of non-limiting example only, further description will be with regard to a mobile terminal 100 such as the mobile phone or the smart phone, and it should be noted that such teachings may apply equally to other types of terminals.

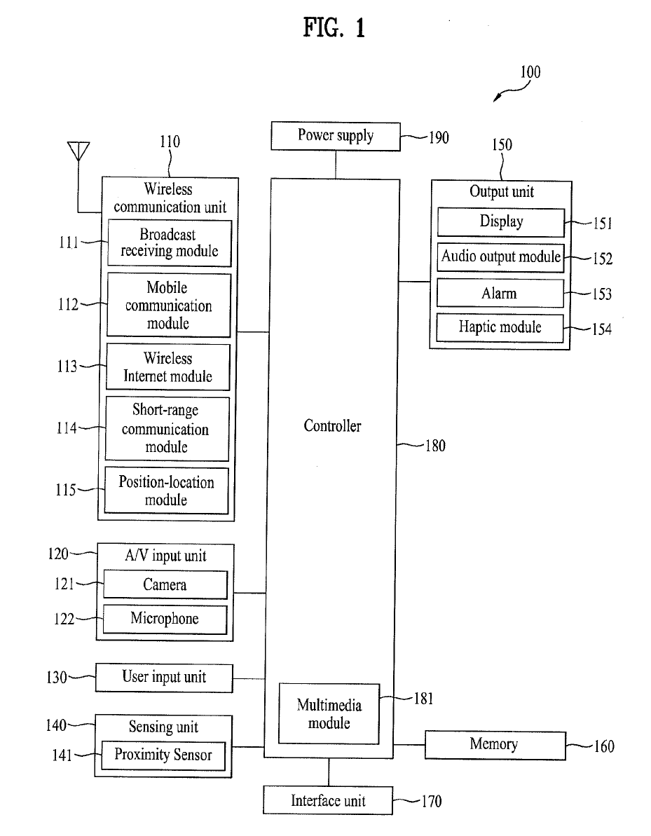

FIG. 1 is a block diagram of a mobile terminal 100 according to an embodiment of the present invention. FIG. 1 shows the mobile terminal 100 according to one embodiment of the present invention including a wireless communication unit 110, an A/V (audio/video) input unit 120, a user input unit 130, a sensing unit 140, an output unit 150, a memory 160, an interface unit 170, a controller 180, a power supply unit 190 and the like. FIG. 1 shows the mobile terminal 100 having various components, but it is understood that implementing all of the illustrated components is not a requirement. Greater or fewer components may alternatively be implemented.

In addition, the wireless communication unit 110 generally includes one or more components which permits wireless communication between the mobile terminal 100 and a wireless communication system or network within which the mobile terminal 100 is located. For instance, the wireless communication unit 110 can include a broadcast receiving module 111, a mobile communication module 112, a wireless Internet module 113, a short-range communication module 114, a position-location module 115 and the like.

The broadcast receiving module 111 receives a broadcast signal and/or broadcast associated information from an external broadcast managing server via a broadcast channel. The broadcast channel may also include a satellite channel and a terrestrial channel. Further, the broadcast managing server generally refers to a server which generates and transmits a broadcast signal and/or broadcast associated information or a server which is provided with a previously generated broadcast signal and/or broadcast associated information and then transmits the provided signal or information to a terminal. The broadcast signal may be implemented as a TV broadcast signal, a radio broadcast signal, and a data broadcast signal, among others. If desired, the broadcast signal may further include a broadcast signal combined with a TV or radio broadcast signal.

In addition, the broadcast associated information includes information associated with a broadcast channel, a broadcast program, a broadcast service provider, etc. The broadcast associated information can be provided via a mobile communication network. In this instance, the broadcast associated information can be received by the mobile communication module 112.

Further, the mobile communication module 112 transmits/receives wireless signals to/from one or more network entities (e.g., a base station, external terminal, server, etc.) via a mobile communication network such as but not limited to GSM (Global System for Mobile communications), CDMA (Code Division Multiple Access), and WCDMA (Wideband CDMA). Such wireless signals may represent audio, video, and data according to text/multimedia message transceivings, among others.

The wireless Internet module 113 supports Internet access for the mobile terminal 100 and may be internally or externally coupled to the mobile terminal 100. The wireless Internet technology can include but is not limited to WLAN (Wireless LAN) (Wi-Fi), Wibro (Wireless broadband), Wimax (World Interoperability for Microwave Access), HSDPA (High Speed Downlink Packet Access) GSM, CDMA, WCDMA, LTE (Long Term Evolution), etc.

Further, wireless Internet access by Wibro, HSPDA, GSM, CDMA, WCDMA, LTE or the like is achieved via a mobile communication network. In this aspect, the wireless Internet module 113 configured to perform the wireless Internet access via the mobile communication network can be the mobile communication module 112.

The short-range communication module 114 facilitates relatively short-range communications. Suitable technologies for implementing this module include radio frequency identification (RFID), infrared data association (IrDA), ultra-wideband (UWB), as well at the networking technologies commonly referred to as Bluetooth and ZigBee, to name a few.

In addition, the position-location module 115 identifies or otherwise obtains the location of the mobile terminal 100. If desired, this module may be implemented with a global positioning system (GPS) module. According to the current technology, the GPS module 115 can precisely calculate current 3-dimensional position information based on at least one of longitude, latitude and altitude and direction (or orientation) by calculating distance information and precise time information from at least three satellites and then applying triangulation to the calculated information. Currently, location and time informations are calculated using three satellites, and errors of the calculated location position and time informations are then amended using another satellite. The GPS module 115 can also calculate speed information by continuously calculating a real-time current location.

Further, the audio/video (A/V) input unit 120 is configured to provide audio or video signals input to the mobile terminal 100. As shown, the A/V input unit 120 includes a camera 121 and a microphone 122. The camera 121 receives and processes image frames of still pictures or video, which are obtained by an image sensor in a video call mode or a photographing mode. The processed image frames can then be displayed on the display 151.

In addition, the image frames processed by the camera 121 can be stored in the memory 160 or can be externally transmitted via the wireless communication unit 110. Optionally, at least two cameras 121 can be provided to the mobile terminal 100 according to environment of usage. Further, the microphone 122 receives an external audio signal while the portable device is in a particular mode, such as phone call mode, recording mode and voice recognition. This audio signal is then processed and converted into electric audio data. The processed audio data is transformed into a format transmittable to a mobile communication base station via the mobile communication module 112 for a call mode. The microphone 122 also generally includes assorted noise removing algorithms to remove noise generated when receiving the external audio signal.

The user input unit 130 generates input data responsive to user manipulation of an associated input device or devices. Examples of such devices include a keypad, a dome switch, a touchpad (e.g., static pressure/capacitance), a jog wheel, a jog switch, etc. In addition, the sensing unit 140 provides sensing signals for controlling operations of the mobile terminal 100 using status measurements of various aspects of the mobile terminal. For instance, the sensing unit 140 may detect an opened/closed status of the mobile terminal 100, relative positioning of components (e.g., a display and keypad) of the mobile terminal 100, a change of position of the mobile terminal 100 or a component of the mobile terminal 100, a presence or absence of user contact with the mobile terminal 100, orientation or acceleration/deceleration of the mobile terminal 100.

For example, the sensing unit 140 includes at least one of a gyroscope sensor, acceleration sensor, a geomagnetic sensor and the like. As an example, consider the mobile terminal 100 being configured as a slide-type mobile terminal. In this configuration, the sensing unit 140 may sense whether a sliding portion of the mobile terminal is open or closed. Other examples include the sensing unit 140 sensing the presence or absence of power provided by the power supply 190, the presence or absence of a coupling or other connection between the interface unit 170 and an external device. In FIG. 1, the sensing unit 140 also includes a proximity sensor 141.

Also, the output unit 150 generates outputs relevant to the senses of sight, hearing, touch and the like. In FIG. 1, the output unit 150 includes the display 151, an audio output module 152, an alarm unit 153, a haptic module 154, a projector module 155 and the like. In more detail, the display 151 is generally implemented to visually display (output) information associated with the mobile terminal 100. For instance, if the mobile terminal is operating in a phone call mode, the display 151 will generally provide a user interface (UI) or graphical user interface (GUI) which includes information associated with placing, conducting, and terminating a phone call. As another example, if the mobile terminal 100 is in a video call mode or a photographing mode, the display 151 may additionally or alternatively display images which are associated with these modes, the UI or the GUI.

The display 151 may also be implemented using known display technologies including, for example, a liquid crystal display (LCD), a thin film transistor-liquid crystal display (TFT-LCD), an organic light-emitting diode display (OLED), a flexible display and a three-dimensional display. The mobile terminal 100 may also include one or more of such displays.

Some of the above displays can also be implemented in a transparent or optical transmittive type, which can be named a transparent display. As a representative example for the transparent display, there is TOLED (transparent OLED) or the like. A rear configuration of the display 151 can be implemented in the optical transmittive type as well. In this configuration, a user can see an object in rear of a terminal body via the area occupied by the display 151 of the terminal body.

Further, at least two displays 151 can be provided to the mobile terminal 100 in accordance with the implemented configuration of the mobile terminal 100. For instance, a plurality of displays can be arranged on a single face of the mobile terminal 100 in a manner of being spaced apart from each other or being built in one body. Alternatively, a plurality of displays 151 can be arranged on different faces of the mobile terminal 100.

In addition, when the display 151 and a sensor for detecting a touch action (hereinafter called a ‘touch sensor’) configures a mutual layer structure (hereinafter called ‘touchscreen’), the display 151 can be used as an input device as well as an output device. Further, the touch sensor can be configured as a touch film, a touch sheet, a touchpad or the like.

In addition, the touch sensor can be configured to convert a pressure applied to a specific portion of the display 151 or a variation of a capacitance generated from a specific portion of the display 151 to an electric input signal. Moreover, the touch sensor can be configured to detect a pressure of a touch as well as a touched position or size.

If a touch input is made to the touch sensor, signal(s) corresponding to the touch is transferred to a touch controller. The touch controller then processes the signal(s) and transfers the processed signal(s) to the controller 180. Therefore, the controller 180 can know whether a prescribed portion of the display 151 is touched.

Further, the proximity sensor 141 in FIG. 1 can be provided to an internal area of the mobile terminal 100 enclosed by the touchscreen or around the touchscreen. The proximity sensor 141 is a sensor that detects a presence or non-presence of an object approaching a prescribed detecting surface or an object existing around the proximity sensor using an electromagnetic field strength or infrared ray without mechanical contact. Hence, the proximity sensor 141 has durability longer than that of a contact type sensor and also has utility wider than that of the contact type sensor.

In addition, the proximity sensor 141 can include one of a transmittive photoelectric sensor, a direct reflective photoelectric sensor, a mirror reflective photoelectric sensor, a radio frequency oscillation proximity sensor, an electrostatic capacity proximity sensor, a magnetic proximity sensor, an infrared proximity sensor and the like. When the touchscreen includes the electrostatic capacity proximity sensor, the touchscreen can detect the proximity of a pointer using a variation of electric field according to the proximity of the pointer. In this instance, the touchscreen (touch sensor) can be classified as the proximity sensor.

The proximity sensor 141 also detects a proximity touch and a proximity touch pattern (e.g., a proximity touch distance, a proximity touch duration, a proximity touch position, a proximity touch shift state, etc.). In addition, information corresponding to the detected proximity touch action and the detected proximity touch pattern can be output to the touchscreen.

Further, the audio output module 152 functions in various modes including a call-receiving mode, a call-placing mode, a recording mode, a voice recognition mode, a broadcast reception mode and the like to output audio data which is received from the wireless communication unit 110 or is stored in the memory 160. During operation, the audio output module 152 outputs audio relating to a particular function (e.g., call received, message received, etc.). The audio output module 152 is often implemented using one or more speakers, buzzers, other audio producing devices, and combinations thereof.

The alarm unit 153 outputs a signal for announcing the occurrence of a particular event associated with the mobile terminal 100. Typical events include a call received event, a message received event and a touch input received event. The alarm unit 153 can output a signal for announcing the event occurrence by vibration as well as video or audio signal. The video or audio signal can be output via the display 151 or the audio output unit 152. Hence, the display 151 or the audio output module 152 can be regarded as a part of the alarm unit 153.

Further, the haptic module 154 generates various tactile effects that can be sensed by a user. Vibration is a representative one of the tactile effects generated by the haptic module 154. A strength and pattern of the vibration generated by the haptic module 154 are also controllable. For instance, different vibrations can be output in a manner of being synthesized together or can be output in sequence.

In addition, the memory unit 160 is generally used to store various types of data to support the processing, control, and storage requirements of the mobile terminal 100. Examples of such data include program instructions for applications operating on the mobile terminal 100, contact data, phonebook data, messages, audio, still pictures, moving pictures, etc. And, a recent use history or a cumulative use frequency of each data (e.g., use frequency for each phonebook, each message or each multimedia) can be stored in the memory unit 160. Moreover, data for various patterns of vibration and/or sound output for a touch input to the touchscreen can be stored in the memory unit 160.

The memory 160 may also be implemented using any type or combination of suitable volatile and non-volatile memory or storage devices including hard disk, random access memory (RAM), static random access memory (SRAM), electrically erasable programmable read-only memory (EEPROM), erasable programmable read-only memory (EPROM), programmable read-only memory (PROM), read-only memory (ROM), magnetic memory, flash memory, magnetic or optical disk, multimedia card micro type memory, card-type memory (e.g., SD memory, XD memory, etc.), or other similar memory or data storage device. And, the mobile terminal 100 can operate in association with a web storage for performing a storage function of the memory 160 on Internet.

The interface unit 170 is often implemented to couple the mobile terminal 100 with external devices. The interface unit 170 receives data from the external devices or is supplied with the power and then transfers the data or power to the respective elements of the mobile terminal 100 or enables data within the mobile terminal 100 to be transferred to the external devices. The interface unit 170 may also be configured using a wired/wireless headset port, an external charger port, a wired/wireless data port, a memory card port, a port for coupling to a device having an identity module, audio input/output ports, video input/output ports, an earphone port and/or the like.

Considering that the wireless Internet module 113 and the short-range communication module 114 are usable as the wireless data ports, each of the wireless Internet module 113 and the short-range communication module 114 can be understood as the interface unit 170.

Further, the identity module is the chip for storing various kinds of information for authenticating a use authority of the mobile terminal 100 and can include User Identify Module (UIM), Subscriber Identify Module (SIM), Universal Subscriber Identity Module (USIM) and/or the like. A device having the identity module (hereinafter called ‘identity device’) can be manufactured as a smart card. Therefore, the identity device is connectible to the mobile terminal 100 via the corresponding port.

When the mobile terminal 110 is connected to an external cradle, the interface unit 170 becomes a passage for supplying the mobile terminal 100 with a power from the cradle or a passage for delivering various command signals input from the cradle by a user to the mobile terminal 100. Each of the various command signals input from the cradle or the power can operate as a signal enabling the mobile terminal 100 to recognize that it is correctly loaded in the cradle.

In addition, the controller 180 controls the overall operations of the mobile terminal 100. For example, the controller 180 performs the control and processing associated with voice calls, data communications, video calls, etc. The controller 180 may also include a multimedia module 181 that provides multimedia playback. The multimedia module 181 may be configured as part of the controller 180, or implemented as a separate component. Moreover, the controller 180 can perform a pattern recognizing process for recognizing a writing input and a picture drawing input carried out on the touchscreen as characters or images, respectively. Further, the power supply unit 190 provides power required by the various components for the mobile terminal 100. The power may be internal power, external power, or combinations thereof.

Various embodiments described herein may be implemented in a computer-readable medium using, for example, computer software, hardware, or some combination thereof. For a hardware implementation, the embodiments described herein may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a selective combination thereof. Such embodiments may also be implemented by the controller 180.

For a software implementation, the embodiments described herein may be implemented with separate software modules, such as procedures and functions, each of which perform one or more of the functions and operations described herein. The software codes can be implemented with a software application written in any suitable programming language and may be stored in memory such as the memory 160, and executed by a controller or processor, such as the controller 180.

In the above description, the mobile terminal according to an embodiment of the present invention is described. In the following description, a display device according to an embodiment of the present invention is explained. Further, the display device can receive and display information on a display of the mobile terminal by being connected to the mobile terminal for communications in-between. For example, the display device can include one of a notebook computer (laptop), a tablet computer, a desktop computer, a television set (e.g., a digital TV set, a smart TV set, etc.) and the like.

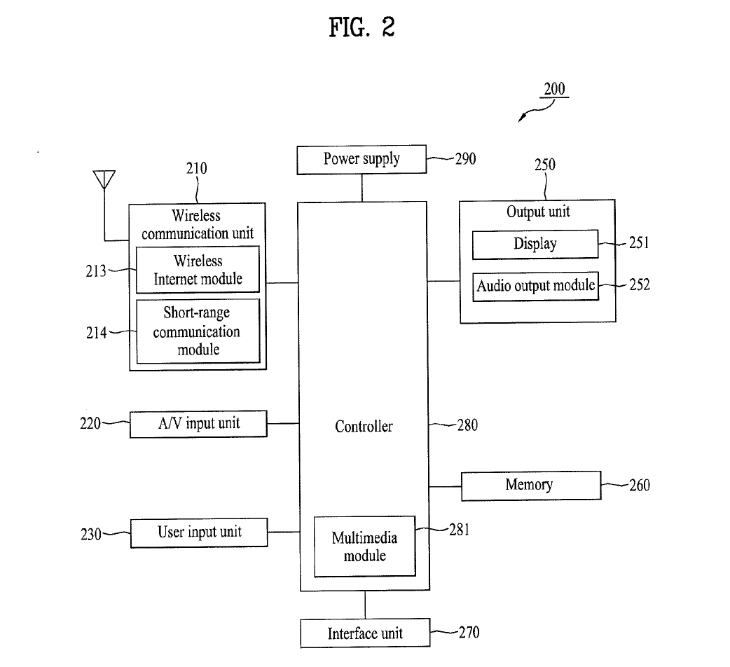

In more detail, FIG. 2 is a block diagram of a display device 200 according to one embodiment of the present invention. As shown, the display device 200 includes a wireless communication unit 210, an A/V (audio/video) input unit 220, a user input unit 230, an output unit 250, a memory 260, an interface unit 270, a controller 280, a power supply unit 290 and the like.

The wireless communication unit 210 can include a wireless Internet module 213 and a short-range communication module 214. The output unit 250 can include a display unit 251 and an audio output module 253. In addition, because the components of the display device 200 are identical or mostly similar to the corresponding components of the above-described mobile terminal, their details will be omitted from the following description for clarity of this disclosure.

Also, because the components shown in FIG. 2 are not entirely mandatory, more or less components can be implemented for the display device. For instance, when the display device 200 is a television, the display device 200 can further include a broadcast receiving module. Moreover, when the display device 200 is the television, the display device 200 may not be provided with the wireless Internet module 213. Of course, the display device 200 can include the wireless Internet module 213. In addition, because the broadcast receiving module is identical or mostly similar to the former broadcast receiving module 111 of the mobile terminal 100 described with reference to FIG. 1, its detail will be omitted from the following description for clarity of this disclosure.

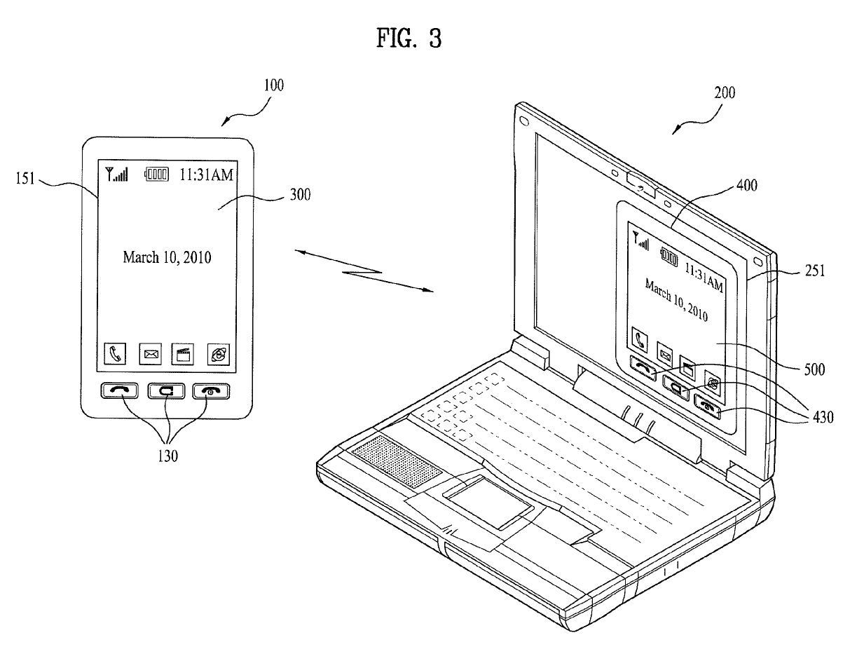

Next, the following description describes how to connect the mobile terminal 100 and the display device 200 together with reference to FIG. 3. In more detail, FIG. 3 is a diagram of a mobile terminal 100 and a display device 200 connected to each other to implement an embodiment of the present invention.

Referring to FIG. 3, the mobile terminal 100 and the display device 200 can be connected to each other via the interface unit 170 of the mobile terminal 100 and the interface unit 270 of the display device 200. The connection between the mobile terminal 100 and the display device 200 can be established by wire communication or wireless communication (e.g., short-range communication, wireless Internet communication, etc.).

FIG. 3 illustrates a state that the mobile terminal 100 and the display device 200 are connected to each other. For clarity and convenience of the following description, in order to respectively identify the components of the mobile terminal 100 and the display device 200, ‘first’ shall be prefixed to the components of the mobile terminal 100, while ‘second’ shall be prefixed to the components of the display device 200.

For instance, the display 151 of the mobile terminal 100 is named a first display unit 151, the controller 180 of the mobile terminal 100 is named a first controller 180, the display 251 of the display device 200 is named a second display unit 251, and the controller 280 of the display device 200 is named a second controller 280. In addition, an image displayed on the first display unit 151 will be named a first screen image 300.

Once the connection between the mobile terminal 100 and the display device 200 is established, the mobile terminal 100 can provide information on a first screen image displayed on the first display unit 151 to the display device 200. In this instance, an application (e.g., a plug-in software, etc.) for processing the information on the first screen image received from the mobile terminal 100 can be installed at the display device 200 in advance.

Hence, when the mobile terminal 100 and the display device 200 are connected to each other, the second controller 280 of the display device 200 can generate and display a monitor window 400 for the first screen image on the second display unit 251. The second controller 280 of the display device 200 then controls an image corresponding to the first screen image to be displayed on the monitor window 400. For clarity of the following description, in order to discriminate this image from a first screen image 300 displayed in the mobile terminal 100, the image displayed on the monitor window 400 will be named a second screen image 500.

In particular, the monitor window 400 can have a shape identical or similar to one face of a housing to which the first display unit 151 of the mobile terminal 100 is attached. Therefore, when prescribed key buttons 130 are provided to the face of the housing, soft key buttons 430 having the same shapes of the prescribed key buttons can be formed at corresponding locations, respectively.

If the soft key button 430 is clicked by a mouse in the display device 200 (or the soft key button 430 is touched when the second display unit 251 includes a touchscreen), the second controller 280 of the display device 200 can send a control signal, which indicates that the soft key button 430 has been manipulated in the display device 200, to the mobile terminal 100.

If so, the first controller 180 of the mobile terminal 100 receives the control signal and can then execute a specific function corresponding to the manipulation of the prescribed key button 130 matching the manipulated soft key button 430 in the mobile terminal 100. Further, the first controller 180 of the mobile terminal 100 can control an image according to the executed specific function to be displayed as the first screen image 300 on the first display unit 151. Subsequently, the first controller 180 of the mobile terminal 100 can send information on the first screen image 300, which includes the image according to the executed specific function, to the display device 200.

If so, the second controller 280 of the display device 200 can control the second screen image 500 corresponding to the received first screen image 300 to be displayed on the monitor window 400. In particular, a user can indirectly manipulate the mobile terminal 100 by manipulating the monitor window 400 of the display device 200 instead of manipulating the mobile terminal 100 in direct. The user can also view the first screen image 30 of the mobile terminal 100 via the second screen image 500 of the display device 200.

In addition, it is not mandatory for the monitor window 400 to have a shape identical or similar to one face of the housing having the first display unit 151 of the mobile terminal 100 loaded thereon. For instance, other icons (e.g., a window close icon, a window minimize icon, a window maximize icon, etc.) can be further shown in the monitor window 400 in addition to one face of the housing. Alternatively, the second screen image 500 can be displayed on the monitor window 400 without the shape of the housing face.

Further, the display device 200 receives information on the first screen image 300 from the mobile terminal 100 and then displays the received information as the second screen image 500 on the monitor window 400. Therefore, the first screen image 300 and the second screen image 500 can share a content image generated from the mobile terminal 100 with each other.

In addition, FIG. 3 exemplarily shows that the content image generated from the mobile terminal 100 is a standby image, by which the present embodiment is non-limited. The content image generated from the mobile terminal 100 includes an image related to all functions, menus or applications executed in the mobile terminal 100.

Next, the following description explains how the mobile terminal 100 provides the information on the first screen image to the display device 200. In more detail, the first controller 180 of the mobile terminal 100 captures the first screen image 300 displayed on the first display unit 151 and can then transmit the captured first screen image as the aforesaid information on the first screen 300 to the display device 200. Afterwards, the second controller 280 of the display device 200 receives the captured first screen image 300 and then controls the received first screen image to be displayed as the second screen image 500 on the monitor window 400.

In doing so, the first screen image 300 and the second screen image 500 can depend on each other for zoom-in or zoom-out operations, for example. In particular, if the first screen image 300 zooms in or out, the second screen image 500 can zoom in or out correspondingly. Moreover, the contents of the first and second screen images 300 and 500 can become dependent on each other.

In addition, the first controller 180 of the mobile terminal 100 can transmit a video signal input to the first display unit 151 to the display device 200 as the information on the first screen image 300. The first display unit 151 of the mobile terminal 100 can then output the video signal as the first screen image 300. Meanwhile, the second controller 280 of the display unit 200 receives the transmitted video signal and can then output the received video signal as the second screen image 500 to the monitor window 400 of the second display unit 251. In particular, the first display unit 151 and the second display unit 251 can share the video signal output from the first controller 180 with each other. Thus, in the following description, the video signal will be named a shared video signal.

Further, as discussed above, the first screen image 300 and the second screen image 500 can depend on each other for zoom-in or zoom-out operations, for example. In particular, if the first screen image 300 zooms in or out, the second screen image 500 can zoom in or out correspondingly. Moreover, contents of the first and second screen images 300 and 500 can become dependent on each other.

In addition, the first controller 180 of the mobile terminal 100 generates a first video signal about a specific content image or a home screen image generated from the mobile terminal 100 and a second video signal independent from the first video signal. The first controller 180 inputs the first video signal to the first display unit 151 and can transmit the second video signal as the information on the first screen image to the display device 200. The first display unit 151 of the mobile terminal 100 can then output the first video signal as the first screen image 300. Meanwhile, the second controller 280 of the display device 200 receives the transmitted second video signal and can then output the received second video signal as the second screen image 500 on the monitor window 400 of the second display unit 251. Besides, each of the first and second video signals should be discriminated from the shared video signal in that the first video signal and the second video signal are independently provided to the first display unit 151 and the second display unit 251, respectively.

In addition, the first screen image 300 and the second screen image 500 can be independent from each other in zoom-in and zoom-out operations, for example. In particular, the second screen image 500 can zoom in or out irrespective of the zoom adjustment of the first screen image 300. Moreover, the first screen image 300 and the second screen image 500 can become independent from each other in their contents. In particular, the first screen image 300 and the second screen image 500 can be different from each other in part at least.

In the above description, as the mobile terminal 100 and the display device 200 are connected to each other, the first screen image 300 displayed on the first display unit 151 and the monitor window 400 and the second screen image 500 displayed on the second display unit 251 are schematically explained.

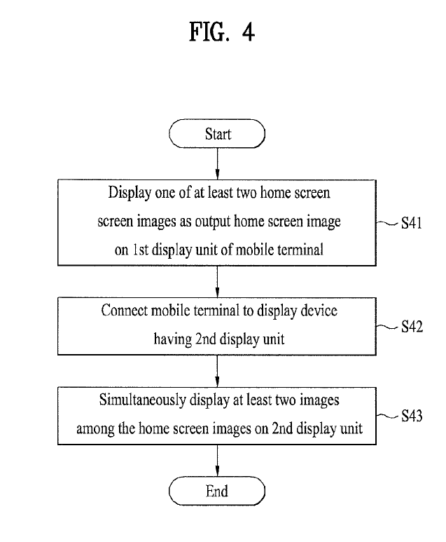

The following description describes how a home screen image for the first display unit 151 of the mobile terminal 100 is displayed on the second display unit 251 of the display device 200, when the mobile terminal 100 and the display device 200 are connected to each other, with reference to FIGS. 4 to 12.

Also, in the following description, both of the first display unit 151 of the mobile terminal 100 and the second display unit 251 of the display device 200 can include touchscreens, respectively. However, the embodiment of the present invention is applied not only to the first and second display units 151 and 251 including the touchscreens but to the first and second display units 151 and 251 include normal displays.

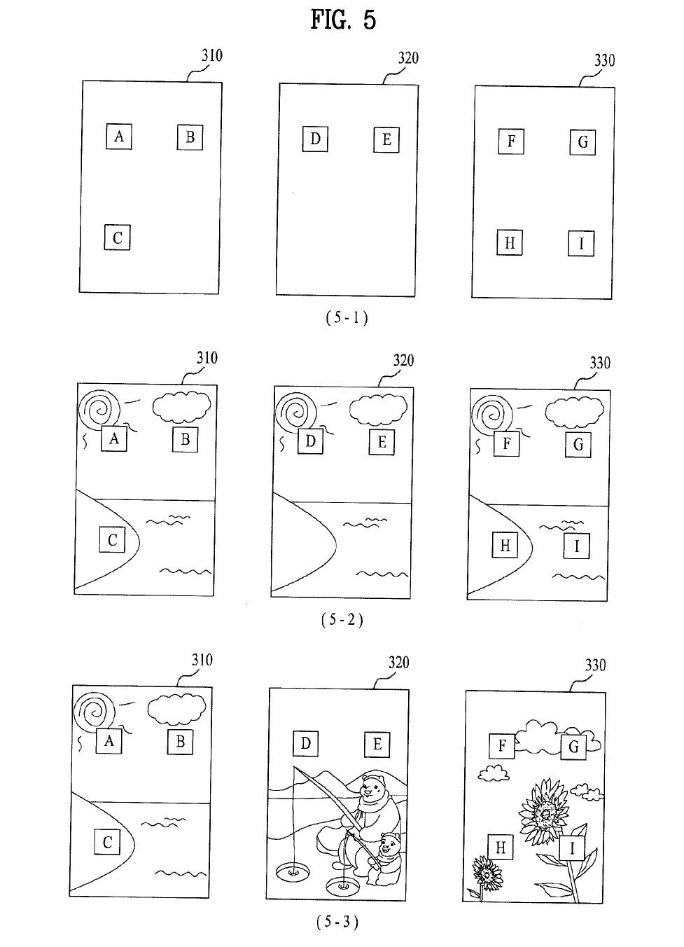

Next, FIG. 4 is a flowchart illustrating an embodiment of the present invention. As shown, one of at least two home screen images is selected from the first display unit 151 of the mobile terminal 100 and displayed as the first screen image 300 on the first display unit 151 of the mobile terminal 100 (S41). The at least two home screen images displayable as the first screen images 300 are explained with reference to FIG. 5.

Then, as shown in FIG. 4, the mobile terminal 100 is connected to the display device 200 (S42). Optionally, the steps S41 and S42 can be switched in order. As the mobile terminal 100 and the display device 200 are connected to each other, the second controller 280 of the display device 200 controls the monitor window 400 to be generated on the second display unit 251.

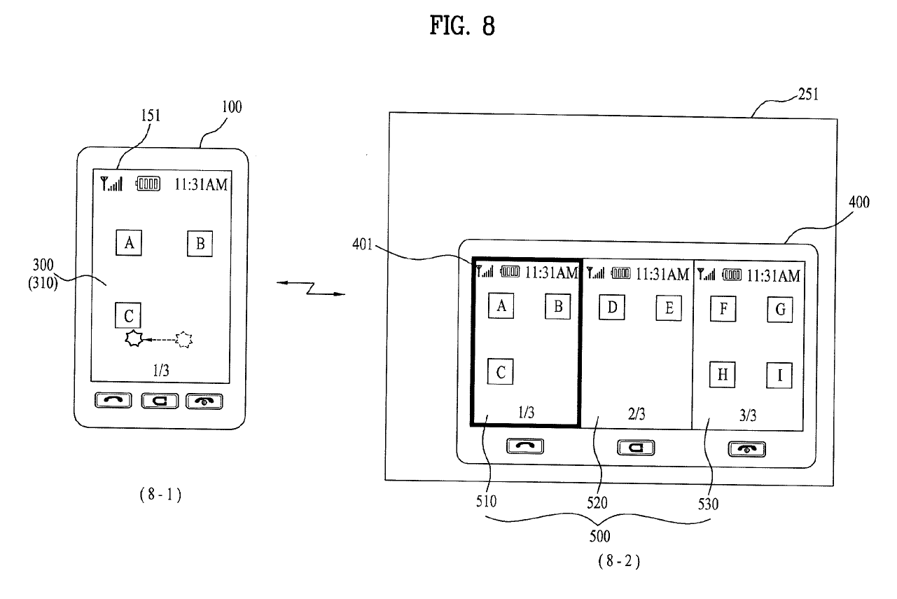

That is, the first controller 180 of the mobile terminal 100 transmits information on the first screen image 300 to the display device 200. In particular, the information on the first screen image can include information on all of the first to third home screen images 310, 320 and 330. The second controller 280 of the display device 200 receives the information on the first screen image from the mobile terminal 100 and displays the received information as a second screen image 500 on the generated monitor window 400. In addition, images corresponding to the first to third home screen images 310, 320 and 330 can be displayed as the second screen image 500 on the monitor window 400 (S43). FIG. 8 illustrates features described in FIG. 4 in more detail.

Next, referring to FIG. 5(5-1), at least two home screen images are prepared in the mobile terminal 100 in advance. In addition, the number of the home screen images can be determined according to a selection made by a user. The following description of the present embodiment assumes there are three home screen images prepared in advance. Further, in the following description, the three home screen images are named a first home screen image 310, a second home screen image 320 and a third home screen image 330, respectively.

In addition, at least one object such as an application icon, a menu icon, a file icon, a widget and the like can be provided to each of the home screen images. Generally, the object can be generated on each home screen, can be moved to another home screen, and can be deleted. However, a prescribed object, which is originally generated before the manufacturer release of the mobile terminal, can be moved between home screen images by a user in the future, but may not be deleted.

In FIG. 5, three objects A, B and C exist in the first home screen image 310, two objects D and E exist in the second home screen image 320, and four objects F to I exist in the third home screen image 330, for example. Each of the home screen images can be sequentially displayed as the first screen image 300 on the first display unit 151 of the mobile in prescribed order according to a user's selection in the mobile terminal 100. This feature will be described in more detail later.

As shown in FIG. 5(5-1), a background image does not exist in the background of the corresponding objects in each of the first, second and third home screen images 310, 320 and 330, by which the present embodiment is non-limited. However, referring to FIG. 5(5-2), corresponding objects can be displayed on a same background image in each of the first, second and third home screen images 310, 320 and 330. In another instance, referring to FIG. 5(5-3), corresponding objects can be displayed on different background images in the first, second and third home screen images 310, 320 and 330, respectively.

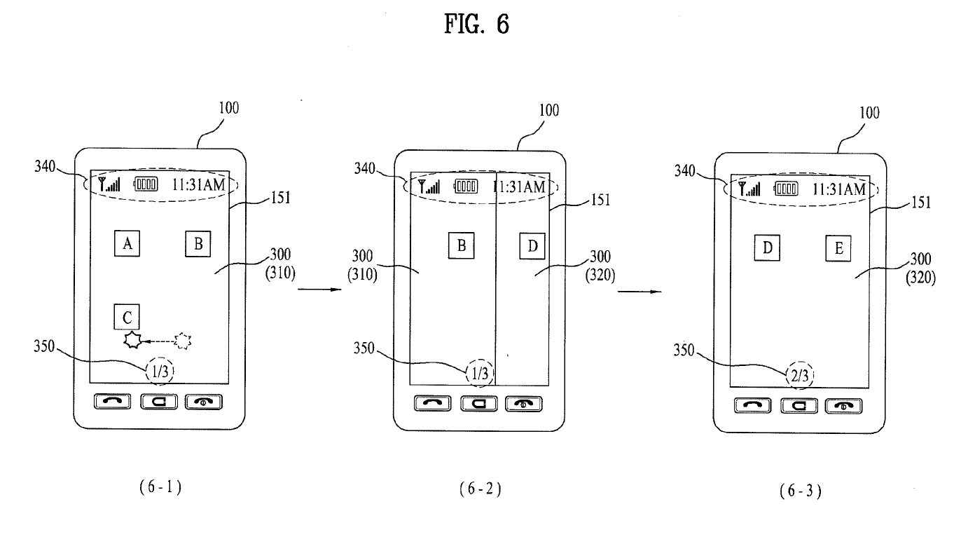

Next, FIG. 6 illustrates a method of displaying the home screen images 310, 320 and 330 as the first screen image 300 on the first display unit 151 in the mobile terminal 100 sequentially in prescribed order. As shown in FIG. 6(6-1), a first home screen image 310 is displayed as the first screen image 300 on the first display unit 151 of the mobile terminal 100. It is not mandatory for the first home screen image 310 only to be displayed as the first screen image 300. That is, the first home screen image 310 can be displayed as the first screen image 300 on the first display unit 151 together with other indicators 340 and 350, for example. In this example, the indicators include terminal status indicators 340 (e.g., a reception strength indicator, a battery indicator, a current time indicator, etc.) and a home screen image page indicator 350, for example. In FIG. 6(6-1), the page indicator 350 represented as ‘⅓’ indicates that the first home screen image 310 displayed as the first screen image 300 is a first image among total of three (3) home screen images.

In addition, a user can switch the first screen image 300 to the second home screen image 320 using the first user input unit 130, for example. Alternatively, when the first display unit 151 includes a touchscreen, the user can perform a prescribed touch gesture (e.g., a touch & drag in one direction) on the touchscreen.

If so, referring to FIG. 6(6-2), the first controller 180 controls a portion of the first home screen image 310 to disappear by sliding out in one direction and also controls a portion of the second home screen image 320 to appear by sliding in along the one direction. Further, even as the first home screen image 310 slides so as to disappear, the indicators 340 and 350 of the first screen image 300 are continuously displayed on the first display unit 151.

Referring to FIG. 6(6-3), as the second home screen image 320 completely appears by sliding and the first home screen image 310 completely disappears, the switching of the first home screen image 310 to the second home screen image 320 is completed. Then, the page indicator 350 represented as ‘⅔’ is displayed in the first screen image 300 to indicate that the second home screen image 320 the second image among the total of three home screen images.

Also, if the user performs a touch & drag in one direction one more time, the third home screen image 330 is displayed. Alternatively, if the user performs a touch & drag is input in a direction opposite to the former direction, the first home screen image 310 is displayed instead of the second home screen image 320.

Further, in the present specification, a home screen image output as the first screen image 300 among the home screen images is called an “output home screen image”. In FIG. 6(6-1), the first home screen image 310 corresponds to the output home screen image; and in FIG. 6(6-2), the second home screen image 320 corresponds to the output home screen image.

In the above description, because the indicators 340 and 350 are separate from the home screen image 310, when the output home screen image is displayed as the first screen image 300, the indicators 340 and 350 are displayed as the first screen image 300 in a manner of being overlapped with the output home screen image, by which the present embodiment is non-limited. Optionally, the home screen images can be configured in a manner that the indicators are included in the corresponding home screen image 310.

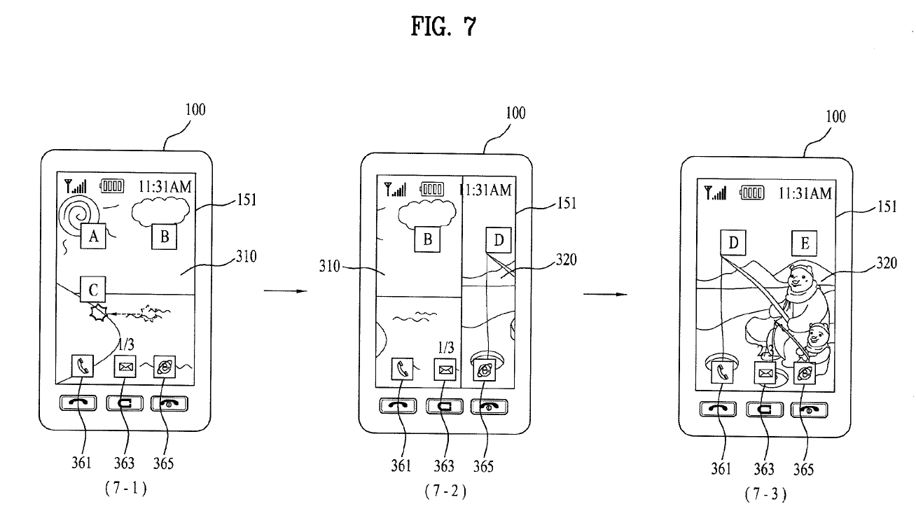

Meanwhile, when the home screen image displayed as the first screen image 300 on the first display unit 151 is switched to another home screen image, FIG. 6 shows that all objects in the first screen image 300 are replaced by other objects, by which the present embodiment is non-limited. This is further described with reference to FIG. 7 as follows.

Referring to FIG. 7(7-1), the first home screen image 310 is displayed as the first screen image 300. As mentioned above, the first home screen image 310 can be displayed together with other indicators 340 and 350, for example. In addition, at least one independent object 361, 363 and 365, which do not belong to any one of the home screen images, can be displayed together with the first home screen image 310. Further, although any home screen image can be displayed as the first screen image 300, the independent objects 361, 363 and 365 can always be displayed in the first screen image 300 together with the displayed home screen image. In particular, the independent objects 361, 363 and 365 can be displayed in the first screen image 300 together with the objects A, B and C of the first home screen image.

Further, in FIG. 7, a phone menu icon 361, a message menu icon 363 and an Internet menu icon 365, each of which has is often frequently used in the mobile terminal 100, are exemplarily shown as the independent objects.

In addition, as discussed above, a user can switch the first screen image 300 displayed on the first display unit 151 to the second home screen image 320 using the first user input unit 130 of the mobile terminal 100. If so, referring to FIG. 7(7-2), the first controller 180 controls a portion of the first home screen image 310 to disappear by sliding out in one direction and also controls a portion of the second home screen image 320 to appear by sliding in along the one direction. Also, even if the first home screen image 310 disappears, the independent objects 361, 363 and 365 of the first screen image 300 can be continuously displayed on the first display unit 151.

Referring to FIG. 7(7-3), as the second home screen image 320 completely appears and the first home screen image 310 completely disappears from the first display unit 151, the switching of the first home screen image 310 to the second home screen image 320 is completed. In particular, the independent objects 361, 363 and 365 are displayed in the first screen image 300 together with the objects D and E of the second home screen image 320.

Next, FIG. 8 illustrates features when the mobile terminal 100 is connected to the display device 200. Referring to FIG. 8(8-1), the first home screen image 310 among first to third home screen images 310, 320 and 330 is displayed as the output home screen image for the first screen image 300 on the first display unit 151 (S41 in FIG. 4). The mobile terminal 100 is then connected to the display device 200 (S42 in FIG. 4).

Referring to FIG. 8(8-2), when the mobile terminal 100 is connected to the display device 200, the second controller 280 of the display device 200 generates and displays the monitor window 400 on the second display unit 251. Further, the first controller 180 of the mobile terminal 100 transmits information on the first screen image 300 to the display device 200. In particular, the information on the first screen image can include information on all of the first to third home screen images 310, 320 and 330.

If so, referring to FIG. 8(8-2), the second controller 280 receives the information on the first screen image from the mobile terminal 100 and then displays the received information as a second screen image 500 on the generated monitor window 400. Further, images corresponding to the first to third home screen images 310, 320 and 330 can be displayed as the second screen image 500 on the monitor window 400 (S43 in FIG. 4).

In addition, FIG. 8(8-2) exemplarily shows that the second screen image 500 includes three subimages, i.e., a first subimage 510, a second subimage 520 and a third subimage 530. In more detail, the first subimage 510 corresponds to the first home screen image 310, the second subimage 520 corresponds to the second home screen image 320, and the third subimage 530 corresponds to the third home screen image 330, for example. The first to third subimages 510, 520 and 530 can also be displayed together with the corresponding indicators 340 and 350 of the first screen image 300. Also, when the independent objects 361, 363 and 365 are displayed on the first screen image 300, the independent objects 361, 363 and 365 can be displayed on the first to third subimages 510, 520 and 530 as well.

Also, FIG. 8(8-1) shows that the first home screen image 310 is displayed as the output home screen image on the first display unit 151 of the mobile terminal 100. Thus, to indicate that the first home screen image 310 is the output home screen image in the mobile terminal 100, the second controller 280 of the display device 200 can control the first subimage 510 corresponding to the first home screen image 310 to be visually distinguished from other subimages 520 and 530 displayed on the monitor window 400 of the second display unit 251. As long as the first subimage 510 is visually distinguishable from other subimages 520 and 530, no limitation is put on the visual distinction. However, FIG. 8(8-2) exemplarily shows that the first subimage 510 is visually distinguished from the other subimages 520 and 530 by displaying a first screen image frame 401 on the first subimage 510.

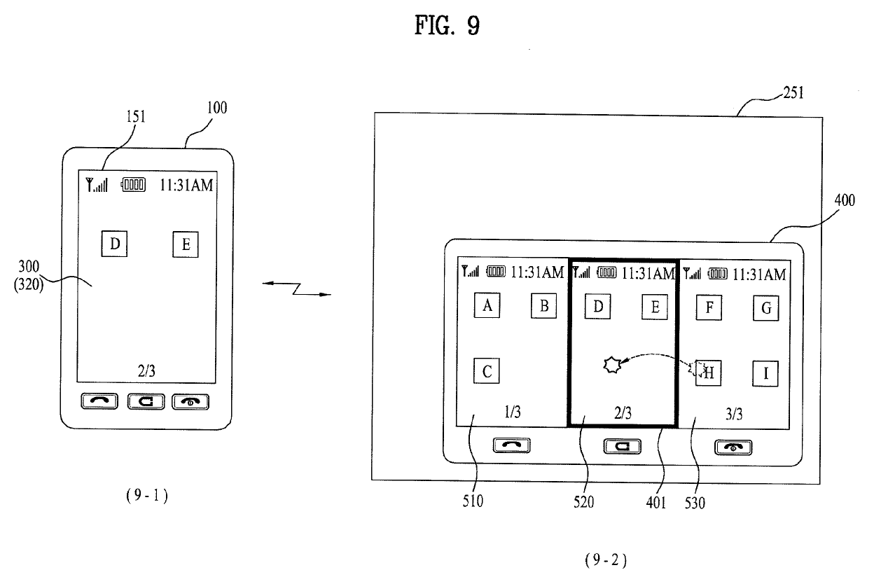

Next, the following description describes how the output home screen image is switched to the second home screen image from the first home screen image with reference to FIGS. 8 and 9. First, if the user performs a touch & drag in one direction on the first display unit 151, as shown in FIG. 8(8-1), a user command for switching the first screen image 300 of the mobile terminal 100 to the second home screen image 320 from the first home screen image 310 can be input.

In response to the user command, referring to FIG. 9(9-1), the first controller 180 of the mobile terminal 100 controls the second home screen image 320 to appear as the first screen image 300 by sliding in while the first home screen image 310 disappears from the first display unit 151 by sliding out. In particular, the second home screen image 320 is displayed as the output home screen image on the first display unit 151 of the mobile terminal 100.

Then, the first controller 180 of the mobile terminal 100 sends a control signal, which indicates that the second home screen image 320 is being displayed as the first screen image 300, to the display device 200. The second controller 280 of the display device 200 receives the control signal, and to indicate that the second home screen image 320 in the mobile terminal 100 is the output home screen image, controls the second subimage 520 corresponding to the second home screen image 320 to be visually distinguished from other subimages 510 and 520 (see FIG. 9(9-2)). Further, FIG. 9(9-2) exemplarily shows that the second subimage 520 is visually distinguished from other subimages 510 and 530 by moving and displaying the first screen image frame 401 to the second subimage 520.

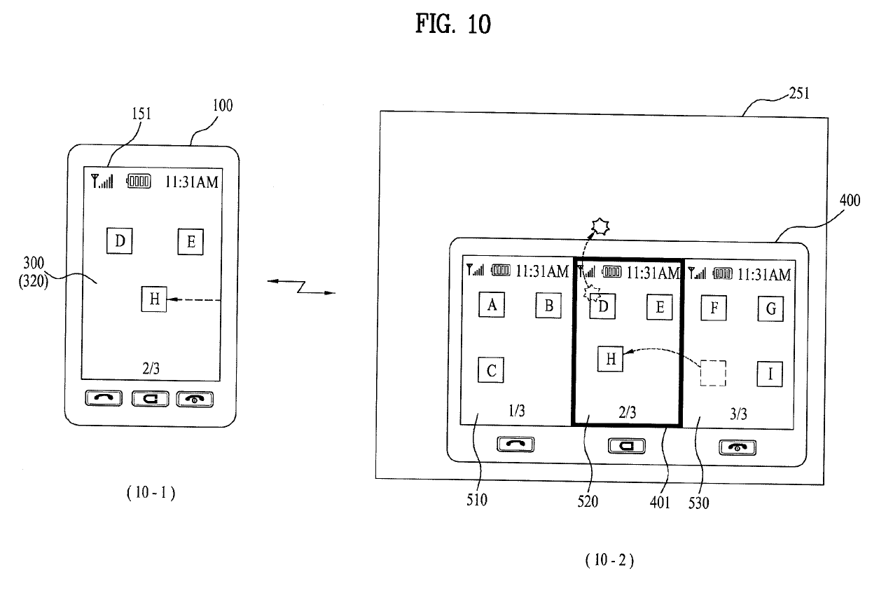

The following description describes how to select and move one object between home screen images with reference to FIGS. 9 and 10. Referring to FIG. 9(9-2), the user can select an object H of the third subimage 530 and then shift the selected object H to the second subimage 520 via the second user input unit 230 of the display unit 200, for example. For example, the user can click the object H of the third subimage 530 using a mouse and then drag the object H to the second subimage 520. Alternatively, when the second display unit 251 includes a touchscreen, the user can touch and drag/flick the object H to the second subimage 520.

If so, the second controller 280 transmits a control signal, which indicates that the user has shifted the object H of the third subimage 530 to the second subimage 520, to the mobile terminal 100. Subsequently, in response to the control signal, the first controller 180 controls the object H to be shifted to the second home screen image 320 from the third home screen image 330. In more detail, and referring to FIG. 10(10-1), when the second home screen image 320 is displayed as the output home screen image (i.e., the first screen image 300) on the first display unit 151 of the mobile terminal 100, the object H is shifted by sliding into the output home screen image from a right side of the first display unit 151 corresponding to the third home screen image 330.

Further, the first controller 180 of the mobile terminal 100 can control information on the first screen image, in which the shifted object H is reflected, to be transmitted to the display device 200. In particular, the information on the first screen having the shifted object H reflected therein can include the first to third home screen images 310, 320 and 330, which reflect the information indicating that the object H has shifted to the second home screen image 320 from the third home screen image 330.

Subsequently, referring to FIG. 10(10-2), the second controller 280 of the display device 200 receives the information on the first screen image, which reflects the shifted object H, from the mobile terminal 100 and controls the received information to be displayed as the second screen image 500 on the monitor window 400 of the second display unit 251. In particular, the first to third subimages 510, 520 and 530 are displayed on the monitor window 400 to correspond to the first to third home screen images 310, 320 and 330 having the shifted object H reflected therein, respectively. Namely, the object H that used to be displayed in the third subimage 530 is shifted to and displayed in the second subimage 520.

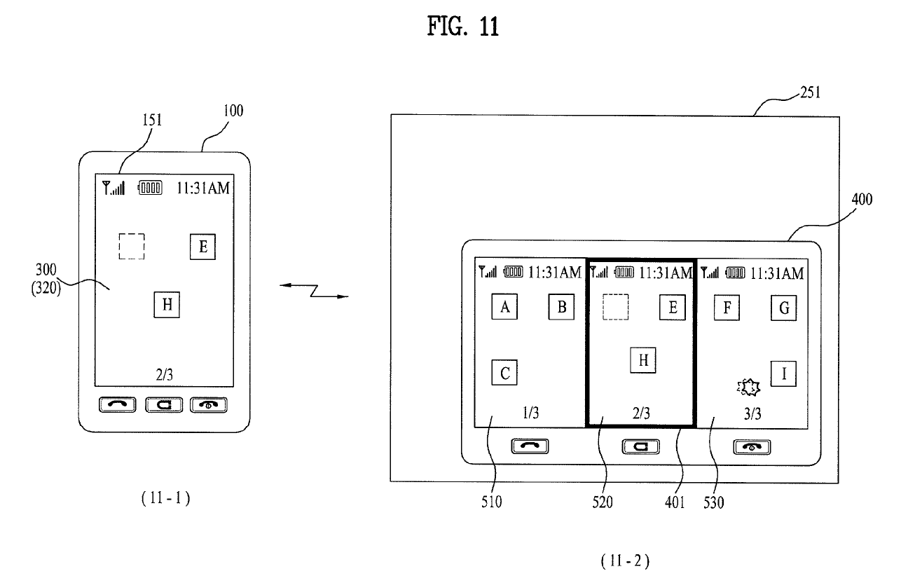

The following description describes how to select and delete one object from the home screen images with reference to FIGS. 10 and 11. In more detail, as shown in FIG. 10(10-2), the user can select an object D of the second subimage 520 and then delete the selected object D via the second user input unit 230, for example. In particular, the user can click the object D using a mouse and then drag the object D outside the monitor window 400. Alternatively, the user can perform a touch and drag or flicking operation when the display includes a touchscreen.

If so, the second controller 280 of the display device 200 transmits a control signal, which indicates the user has selected and deleted the object D of the second subimage 520, to the mobile terminal 100. Subsequently, in response to the control signal, the first controller 180 of the mobile terminal 100 controls the object D to be deleted from the second home screen image 320 corresponding to the second subimage 520. For example, referring to FIG. 11(11-1), when the second home screen image 320 is displayed as the output home screen image (i.e., the first screen image 300) on the first display unit 151, the object D disappears from the output home screen image.

The first controller 180 can also control information on the first screen image, in which the deleted object D is reflected, to be transmitted to the display device 200. In particular, the information on the first screen having the deleted object D reflected therein can include the first to third home screen images 310, 320 and 330, which reflect the information indicating that the object D has deleted from the second home screen image 320.

Subsequently, referring to FIG. 11(11-2), the second controller 280 of the display device 200 receives the information on the first screen image, which reflects the deleted object D, from the mobile terminal 100 and then controls the received information to be displayed as the second screen image 500 on the monitor window 400 of the second display unit 251. In particular, the first to third subimages 510, 520 and 530 are displayed on the monitor window 400 to correspond to the first to third home screen images 310, 320 and 330 having the deleted object D reflected therein, respectively. Namely, the object D that used to be displayed in the second subimage 520 can be deleted from the second subimage 520.

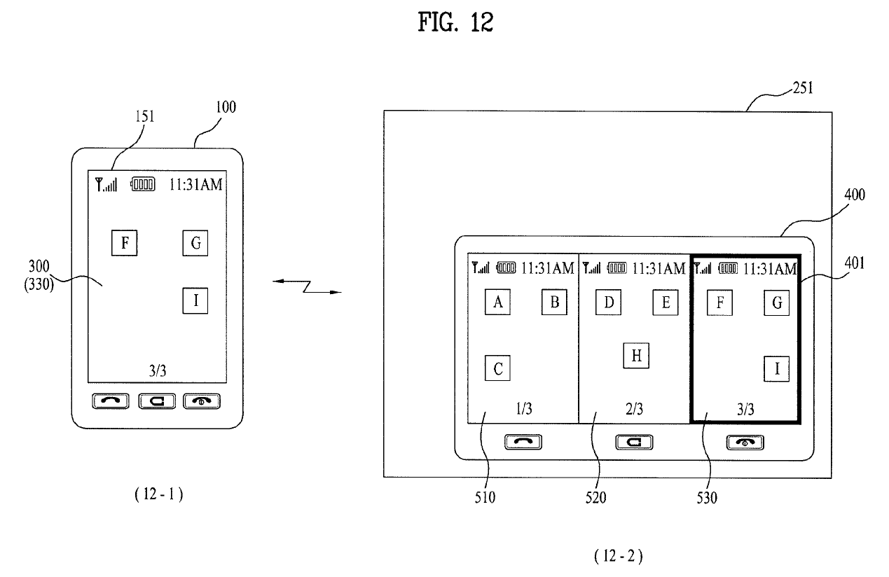

Next, the following description describes a method of switching the output home screen image of the mobile terminal 100 to the third home screen image from the second home screen image if a prescribed user input command is input to the display device 200 with reference to FIGS. 11 and 12.

Referring to FIG. 11(11-2), the user cans switch the output home screen image of the mobile terminal 100 to become the third home screen image 330 via the second user input unit 230 of the display device 200. For instance, the user double click the third subimage 530 in the monitor window 400 of the second display unit 251 via the mouse or by double touching the subimage 530 when the second display unit 251 includes a touchscreen.

If so, the second controller 280 of the display device 200 transmits a control signal, which indicates that the user switched to the third home screen image 330, to the mobile terminal 100. Then, in response to the control signal, and referring to FIG. 12(12-1), the first controller 180 of the mobile terminal 100 controls the third home screen image 330 to become the output home screen image (i.e., the first screen image 300) in a manner that the third home screen image 330 appears from a right side of the first display unit 151 by sliding in while the second home screen image 320 disappears by sliding out to a left side of the first display unit 151.

The first controller 180 of the mobile terminal 100 also controls the information on the first screen image, which indicates that the third home screen image 330 is the output home screen image, to be transmitted to the display device 200. Then, as shown in FIG. 12(12-2), the second controller 280 of the display device 200 receives the information on the first screen image, which indicates that the third home screen image 330 is the output home screen image, and controls the received information to be displayed as the second screen image 500 on the monitor window 400 of the second display unit 251.

In particular, the second controller 280 of the display device 200 controls the third subimage 530, which corresponds to the third screen image 330, to be visually distinguished from other subimages 510 and 520 in the second screen image 500. FIG. 12(12-2) exemplarily shows that the third subimage 530 is visually distinguished from other subimages 510 and 52 using the first screen image frame 401.

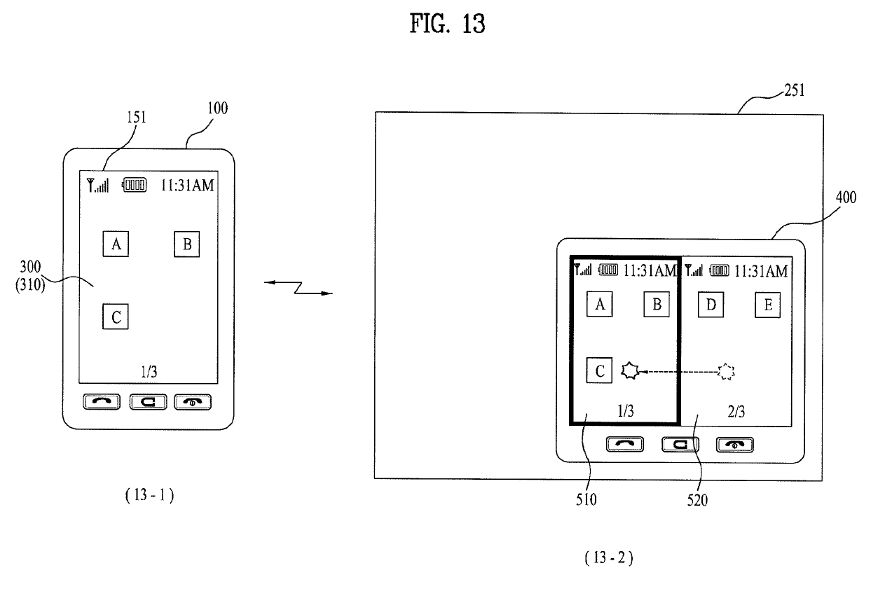

In the above descriptions, when the mobile terminal 100 and the display device 200 are connected to each other, the subimages (i.e., the first to third subimages 510, 520 and 530) corresponding to the home screen images (i.e., the first to third home screen images 310, 320 and 330) for the mobile terminal 100 are displayed on the monitor window 400 of the second display unit 251, by which the present embodiment is non-limited. For instance, only some and not all of the subimages corresponding to the home screen images can be displayed on the monitor window 400 of the second display unit 251. This is further explained with reference to FIGS. 13 to 15 as follows.

In particular, FIGS. 13 to 15 are diagrams of screen configurations of the mobile terminal and the display unit of the display device according to an embodiment of the present invention. Referring to FIG. 13(13-1), the first home screen image 310 among the first to third home screen images 310, 320 and 330 is displayed as the output home screen image for the first screen image 300 on the first display unit 151 of the mobile terminal 100.

As the mobile terminal 100 and the display device 200 are connected to each other, and referring to FIG. 13(13-2), the second controller 280 of the display device 200 controls the monitor window 400 to be generated from the second display unit 251. The first controller 180 of the mobile terminal 100 also controls information on the first screen image to be transmitted to the display device 200. In particular, the information on the first screen image can include information on some of the home screen images (the first to third home screen images 310, 320 and 330) including the first home screen image 310, which is the output home screen image. In this following description, some of the home screen images include the first home screen image 310 and the second home screen image 320.

If so, referring to FIG. 13(13-2), the second controller 280 of the display device 200 receives the information on the first screen image and controls the received information to be displayed as the second screen image 500 on the generated monitor window 400. Further, the first and second subimages 510 and 520 respectively corresponding to the first and second home screen images 310 and 320 are displayed as the second screen image 500 on the monitor window 400.

Also, in order to indicate that the first home screen image 310 in the mobile terminal 100 is the output home screen image, the second controller 280 of the display device 200 controls the first screen image frame 401 to be displayed on the first subimage 510 corresponding to the first home screen image 310.

Referring to FIG. 13(13-2), the user can input a command slidably shift the first and second subimages 510 and 520 within the monitor window 400 via the second user input unit 230 of the display device 200 or via a touch gesture. For instance, the user command can be input by clicking the second screen image 520 and then dragging in one direction via the mouse. Alternatively, the user can use a touch and drag of flicking operation.

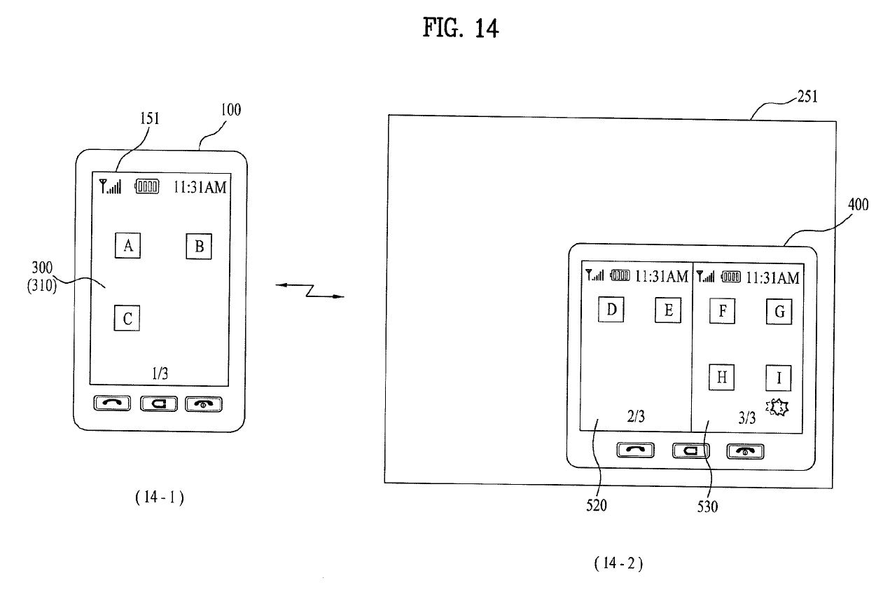

If so, the second controller 280 of the display device 200 transmits a control signal, which indicates that the user command is for slidably shifting the first and second subimages 510 and 520, to the mobile terminal 100. In response to the control signal, the first controller 180 of the mobile terminal 100 controls information on the first screen, which includes the information on the second and third home screen images 320 and 330, to be transmitted to the display device 200. Referring to FIG. 14(14-1), the first controller 180 of the mobile terminal 100 controls the first home screen image 310 to keep being displayed as the output home screen image for the first screen image 300.

Referring to FIG. 14(14-2), the second controller 280 of the display device 200 receives the information on the first screen image, which includes the information on the second and third home screen images 320 and 330, from the mobile terminal 100 and controls the received information to be displayed as the second screen image 500 on the monitor window 400 of the second display unit 251. In this example, the second and third subimages 520 and 530 corresponding to the second and third home screen image 320 and 330 are displayed as the second screen image 500 on the monitor window 400.

The second controller 280 of the display device 200 also can control the third subimage 530 to be displayed on the monitor window 400 together with the second subimage 520 in a manner of appearing by sliding in to the left from a right side while the first and second subimages 510 and 520 are shifted to the left to enable the first subimage 510 to disappear over the left side. Also, because each of the second and third subimages 520 and 530 fails to correspond to the first home screen image 310, which is the output home screen image, in the monitor window 400, the first screen image frame 401 may not be displayed.

Referring to FIG. 14(14-2), the user can input a command to enable the output home screen image of the mobile terminal 100 to become the third home screen image 330 via the second user input unit 230 of the display device 200. If so, the second controller 280 of the display device 200 transmits a control signal, which indicates that the user command for enabling the output home screen image to become the third home screen image 330 has been input, to the mobile terminal 100.

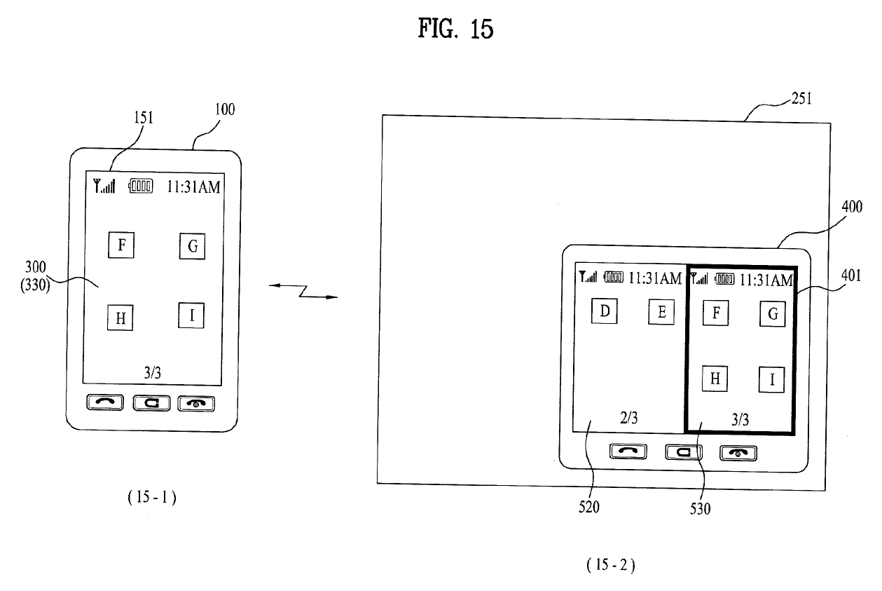

If so, in response to the control signal, and referring to FIG. 15(15-1), the first controller 180 of the mobile terminal 100 controls the third home screen image 330 to become the output home screen image (i.e., the first screen image 300) in a manner that the first home screen image 310 disappears from the first display unit 151 by sliding out over a left side, that the second home screen image 320 slidably appears from a right side and then slidably disappears over the left side, and that the third home screen image 330 appears by sliding in from the right side.

Afterwards, the first controller 180 of the mobile terminal 100 controls information on the first screen image, which indicates that the third home screen image 330 is the output home screen image, to be transmitted to the display device 200. If so, the second controller 280 of the display device 200 then receives the information on the first screen image, which indicates that the third home screen image 330 is the output home screen image, from the mobile terminal 100. Also, to indicate that that the third home screen image 330 is the output home screen image in the mobile terminal 100, and referring to FIG. 15(15-2), the second controller 280 of the display device 200 controls the third subimage 530, which corresponds to the third home screen image 330, to be visually distinguished from the second subimage 520 in the second screen image 500 displayed on the monitor window 400 of the second display unit 251. As mentioned in the foregoing description, FIG. 15(15-2) exemplarily shows that the third subimage 530 is visually distinguished from the second subimage 520 by displaying the first screen image frame 401 on the third subimage 530.

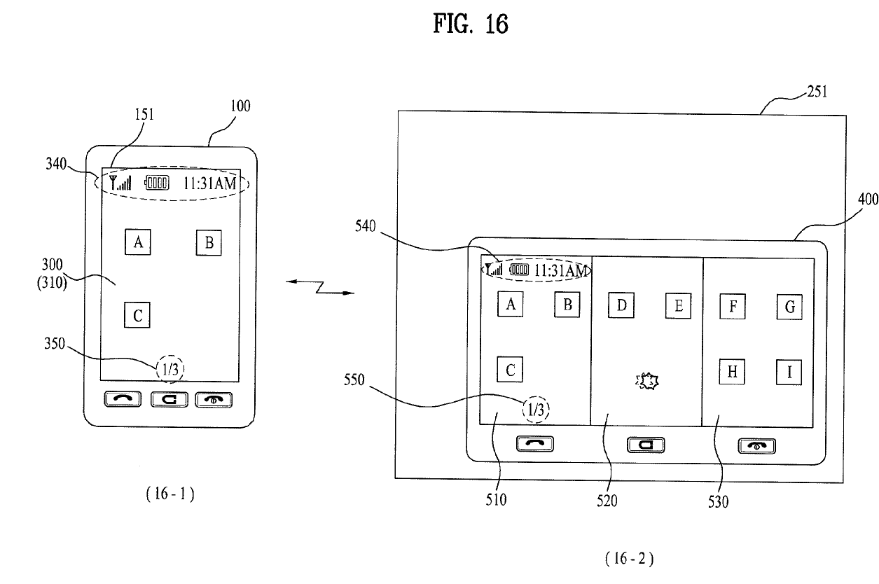

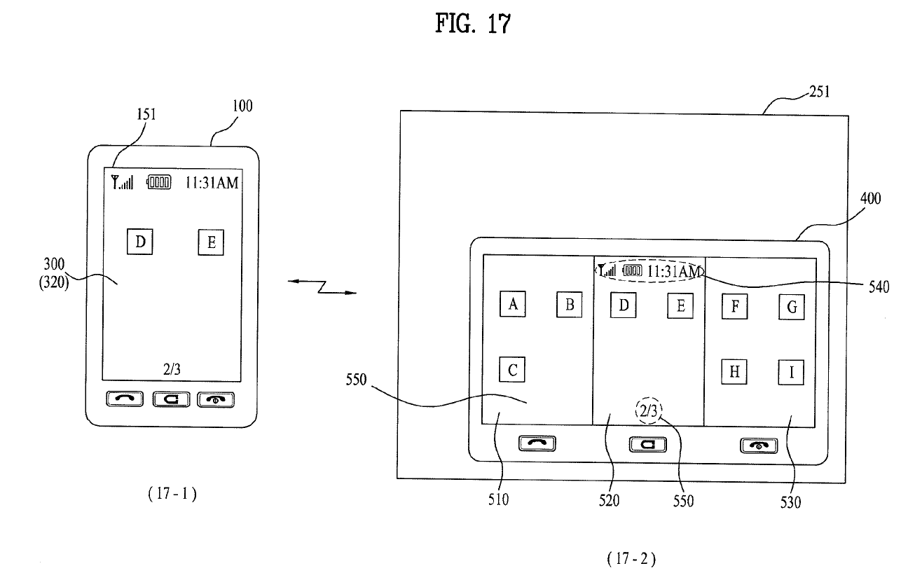

In the above description, the first screen image frame 401 is displayed on the monitor window 400 of the second display unit 251, whereby a user can be aware about which one of several subimages in the monitor window 400 corresponds to the output home screen image. However, in order for the user to be aware which one of several subimages in the monitor window 400 corresponds to the output home screen image, it is not mandatory for the first screen image frame 401 to be displayed. This is explained in more detail with reference to FIGS. 16 and 17.

In particular, FIGS. 16 and 17 are diagrams of screen configurations of the mobile terminal and the display unit of the display device according to an embodiment of the present invention. Referring to FIG. 16(16-1), the first home screen image 310 among the first to third home screen images 310, 320 and 330 is displayed as the output home screen image for the first screen image 300 on the first display unit 151 of the mobile terminal 100.

When the display device 200 is connected to the mobile terminal 100, and referring to FIG. 16(16-2), the first to third subimages 510, 520 and 530 respectively corresponding to the first to third home screen images 310, 320 and 330 are displayed on the monitor window 400 of the second display unit 251. This is explained in the foregoing description and its details will be omitted from the following description for clarity of this disclosure.

Thus, to indicate that the first home screen image 310 is the output home screen image in the first mobile terminal 100, the second controller 280 of the display device 200 controls second indicators 540 and 550, which correspond to the indicators 340 and 350 (hereinafter named first indicators) of the first screen image 300, respectively, to be displayed on the first subimage 510 corresponding to the first home screen image 310 in the second screen image 500 displayed on the monitor window 400 of the second display unit 251.

Referring to FIG. 16(16-2), the user can enable the output home screen image of the mobile terminal 100 to become the second home screen image 320 via the second user input unit 230 of the display device 200 (e.g., the second subimage is double clicked). If so, and as mentioned in the foregoing description, referring to FIG. 17(17-1), the second home screen image 320 is displayed as the output home screen image on the first display unit 151 of the mobile terminal 100. As mentioned in the foregoing description, the mobile terminal 100 can transmit the information on the first screen image, which indicates that the second home screen image 320 is the output home screen image, to the display device 200.

If so, the second controller 280 of the display device 200 receives the information on the first screen image, which indicates that the second home screen image 320 is the output home screen image. Then, referring to FIG. 17(17-2), to indicate that the second home screen image 320 is the output home screen image in the mobile terminal 100, the second controller 280 of the display device 200 controls the second indicators 540 and 550 to be displayed in the second subimage 520 corresponding to the second home screen image 320 on the monitor window 400 of the second display unit 251.

Therefore, a user recognizes in which one of the subimages the second indicators are displayed and confirms that a specific one of the home screen images is the output home screen image in the mobile terminal 100.

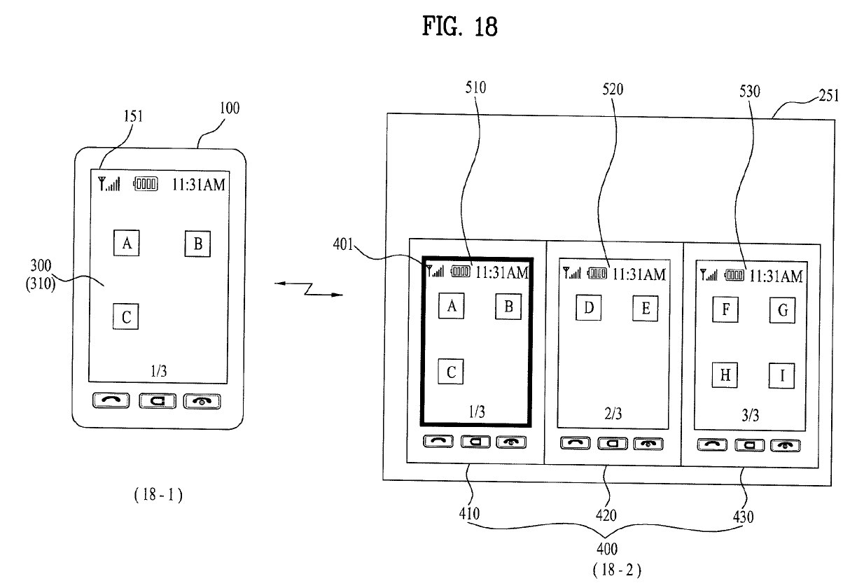

In the above description, when the mobile terminal 100 and the display device 200 are connected to each other, one monitor window 400 is generated from the second display unit 251 and the subimages corresponding to the home screen images are displayed as the second screen image on the monitor window 400, by which the present embodiment is non-limited. For instance, when the mobile terminal 100 and the display device 200 are connected to each other, at least two monitor windows can be generated from the second display unit 251. This is explained in detail with reference to FIG. 18 as follows.

In more detail, FIG. 18 is a diagram of screen configurations of the mobile terminal and the display unit of the display device according to an embodiment of the present invention. Referring to FIG. 18(18-1), the first home screen image 310 among the first to third home screen images 310, 320 and 330 is displayed as the output home screen image for the first screen image 300 on the first display unit 151 of the mobile terminal 100.

As the display device 200 is connected to the mobile terminal 100, the first controller 180 of the mobile terminal 100 controls the information on the first screen image to be transmitted to the display device 200. In particular, the information on the first screen image can include information on all of the first to third home screen images 310, 320 and 330.

Afterwards, the second controller 280 of the display device 200 receives the information on the first screen image. Referring to FIG. 18(18-2), the second controller 280 of the display device 200 controls monitor windows, of which number is equal to that of the home screen images included in the received information, (i.e., a first monitor window 410, a second monitor window 420, and a third monitor window 430) to be displayed on the second display unit 251. In addition, the second controller 280 of the display device 200 controls the first to third subimages 510, 520 and 530 respectively corresponding to the first to third home screen images 310, 320 and 330 to be displayed on the first to third monitor windows 410, 420 and 430, respectively.

As mentioned in the foregoing description, to indicate that the first home screen image 310 is the output home screen image in the mobile terminal 100, and referring to FIG. 18(18-2), the second controller 280 of the display device 200 displays the first screen image frame 401 on the first subimage 510 of the first monitor window 410. Therefore, the first monitor window 410 can be visually distinguished from the second and third monitor windows 420 and 430.

It is apparent to those skilled in the art that the concept of respectively displaying the subimages on the corresponding monitor windows, as shown in FIG. 18(18-2), is applicable to the foregoing embodiments of the present invention and the following embodiment of the present invention.

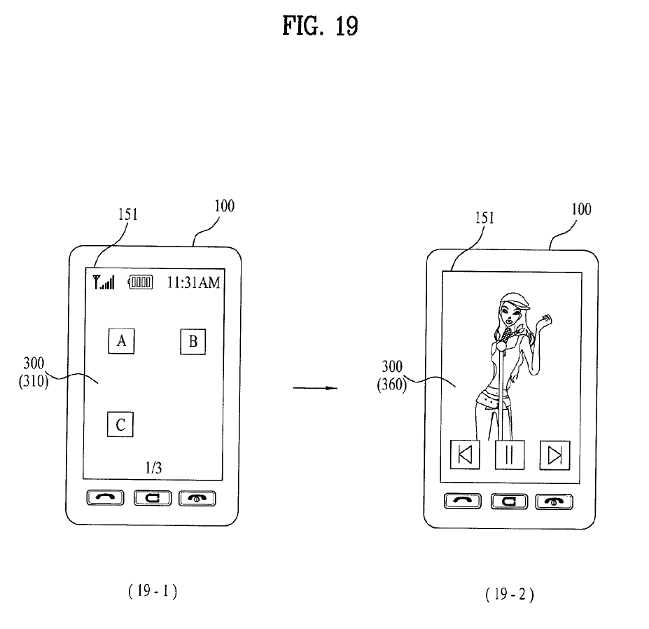

The following description describes how the monitor window 400 is changed, when the mobile terminal 100 and the display device 200 have been connected to each other and one object is selected and executed from the output home screen image of the mobile terminal 100 with reference to FIGS. 19 to 21.

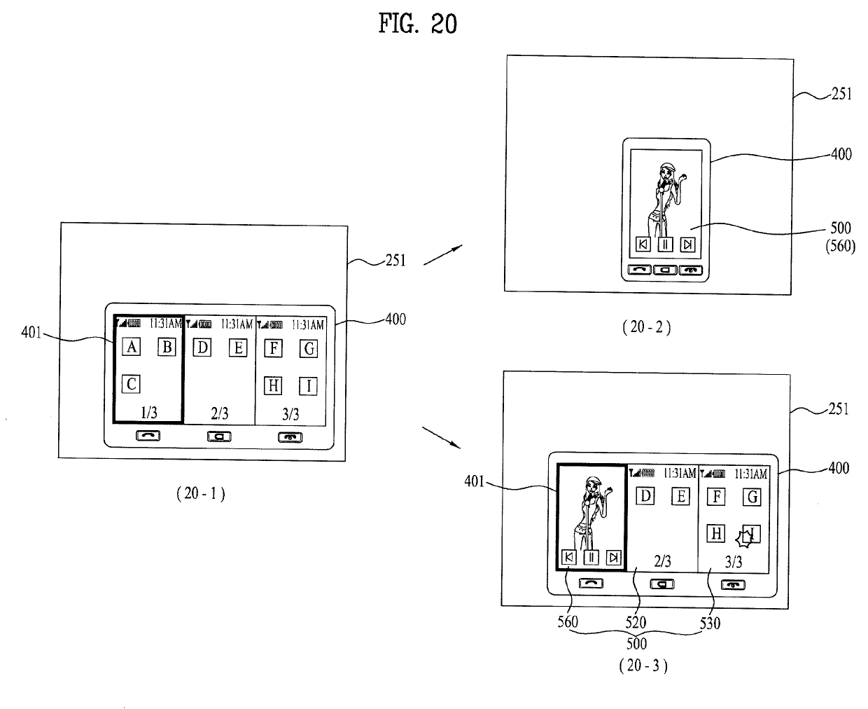

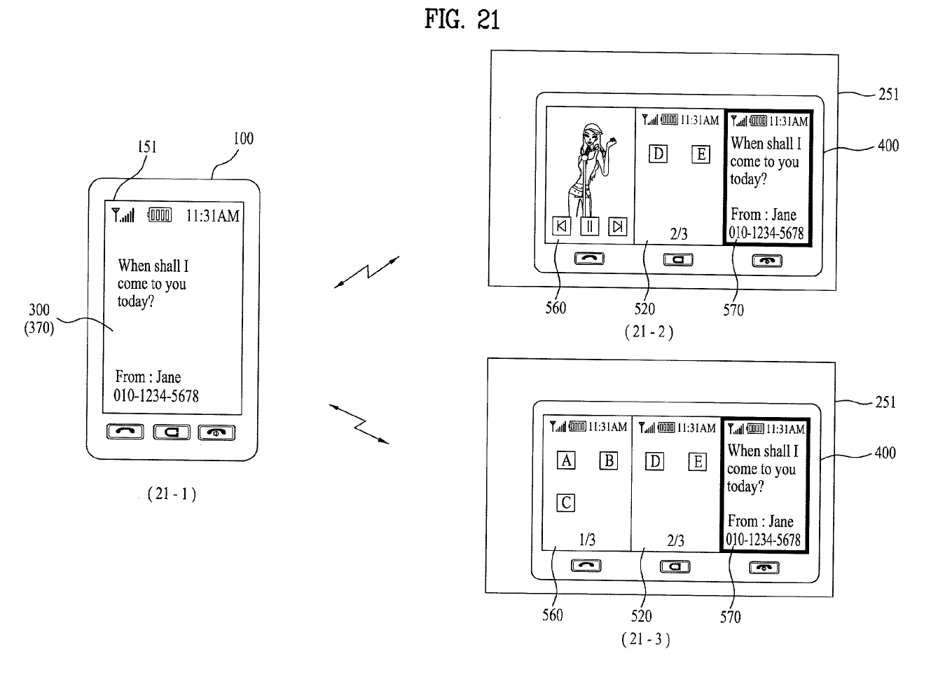

In particular, FIG. 19 is a front diagram of screen configurations of the mobile terminal, FIG. 20 is a diagram of screen configurations of the display unit of the display device, and FIG. 21 is a diagram of screen configurations of the mobile terminal and the display unit of the display device according to embodiments of the present invention. In the following description, the mobile terminal 100 and the display device 200 are connected to each other. In particular, the first home screen image 310 is displayed as the output home screen image for the first screen image 300 on the first display unit 151 of the mobile terminal 100 (see FIG. 19(19-1)).

In addition, the monitor window 400 is displayed on the second display unit 251 of the display device 200 (see FIG. 20 (20-1)). These features are discussed above and will not be repeated. Then, an object A of the first home screen image 310 is selected and executed in the first display unit 151 of the mobile terminal 100, for example. When the first display unit 151 includes a touchscreen, the object can be executed by being touched. The following description assumes that the object A is a multimedia play menu icon.

Subsequently, the first controller 180 of the mobile terminal 100 plays back a corresponding multimedia content. Referring to FIG. 19(19-2), the first controller 180 of the mobile terminal 100 controls a corresponding multimedia content image 360 to be displayed as the first screen image 300 on the first display unit 151. For clarity of the following description, the multimedia content image displayed on the first display unit 151 is named a first multimedia content image.

The first controller 180 of the mobile terminal 100 then transmits information on the first screen image to the display device 200. In particular, the information on the first screen image can include image information of the multimedia content only. In addition, the second controller 280 of the display device 200 receives the information on the first screen.

Referring to FIG. 20(20-2), the second controller 280 of the display device 200 controls the multimedia content image to be displayed as the second screen image 500 on the monitor window 400 of the second display unit 251 instead of the first to third subimages 510, 520 and 530 as shown in FIG. 20(20-1). For clarity of the following description, the multimedia content image displayed on the second display unit 251 is named a second multimedia content image.

Meanwhile, the information on the first screen image can include the second and third home screen image 320 and 330 as well as the image information of the multimedia content. The first home screen image 310, at which the object A is located, can then be excluded from the information on the first screen image. Further, the second controller 280 of the display device 200 receives the information on the first screen image.

Referring to FIG. 20(20-3), the second controller 280 of the display device 200 controls the second multimedia content image 560 and the second and third subimages 520 and 530 corresponding to the second and third home screen images 320 and 330 to be displayed as the second screen image 500 on the monitor window 400 of the second display unit 151. In particular, the second multimedia content image 560 can be displayed instead of the first subimage 510.

Referring to FIG. 20(20-3), when the second multimedia content image 560 is displayed on the second display unit 251 of the display device 200 together with the second and third subimages 520 and 530, another object of the third subimage 530 can be selected, for example. This is explained in more detail with reference to FIG. 20(20-3) and FIG. 21 as follows.

That is, as the multimedia play menu is being executed in the mobile terminal 100 and the second multimedia content image 560 is displayed on the second display unit 251 of the display device 200 together with the second and third subimages 520 and 530, an object I of the third subimage 530 can be selected, for example. The following description assumes that the object I is a message menu icon.

A user command for selecting the object I of the third subimage 530 can be input via the second user input unit 230 of the display device 200. For instance, the user command can be input in a manner that the object I of the third subimage 530 displayed on the second display unit 251 is clicked via the mouse. Alternatively, when the second display unit 251 includes a touchscreen, the user command can be input by touching the object I of the third subimage 530 displayed on the second display unit 251.

If so, the second controller 280 of the display device 200 transmits a control signal, which indicates that the user command for selecting the object I has been input, to the mobile terminal 100. In response to this control signal, the first controller 180 of the mobile terminal 100 controls a message menu to be executed by multitasking while the multimedia play menu is executed. In particular, the first controller 180 executes the message menu and can control a corresponding message menu image 370 to be displayed as the first screen image 300 on the first display unit 151 (see FIG. 21(21-1)). For clarity of the following description, the message menu image displayed on the first display unit 151 is named a first message menu image.

Subsequently, the first controller 180 of the mobile terminal 100 can transmit information on the first screen image to the display device 200. The information on the first screen image can include the first multimedia content image currently executed by multitasking, the newly executed message image and the second home screen image 320 together. In this instance, the first home screen image 310 having the object A located therein and the third home screen image 330 having the object I located therein can be excluded from the information on the first screen image.

Further, the second controller 280 of the display device 200 receives the information on the first screen image and controls the second multimedia content image 560, the second subimage 520 corresponding to the second home screen images 320 and a second message image 570 corresponding to the first message image to be displayed as the second screen image 500 on the monitor window 400 of the second display unit 251 (see FIG. 21(21-2)). In particular, the second multimedia content image 560 and the second message image 570 can be displayed instead of the first subimage 510 and the third subimage 350, respectively.

Meanwhile, in response to the control signal indicating that the user command for selecting the object I has been input, the first controller 180 of the mobile terminal 100 stops executing the multimedia play menu and then controls the message menu to be executed. Referring to FIG. 21(21-1), the first controller 180 of the mobile terminal 100 controls the first message menu image 370 to be displayed as the first screen image 300 on the first display unit 151.

Subsequently, the first controller 180 of the mobile terminal 100 transmits the information on the first screen image to the display device 200. The newly executed message image and the first and second home screen images 310 and 320 can be displayed in the first screen image together. The third home screen images having the object I located therein can also be excluded from the information on the first screen image.

In addition, the second controller 280 of the display device 200 receives the information on the first screen image and controls the first and second subimages 510 and 520 respectively corresponding to the first and second home screen images 510 and 520 and the second message image 570 corresponding to the first message image to be displayed as the second screen image 500 on the monitor window 400 of the second display unit 251 (see FIG. 21(21-3)). In particular, the second message image 570 can be displayed instead of the third subimage 530.

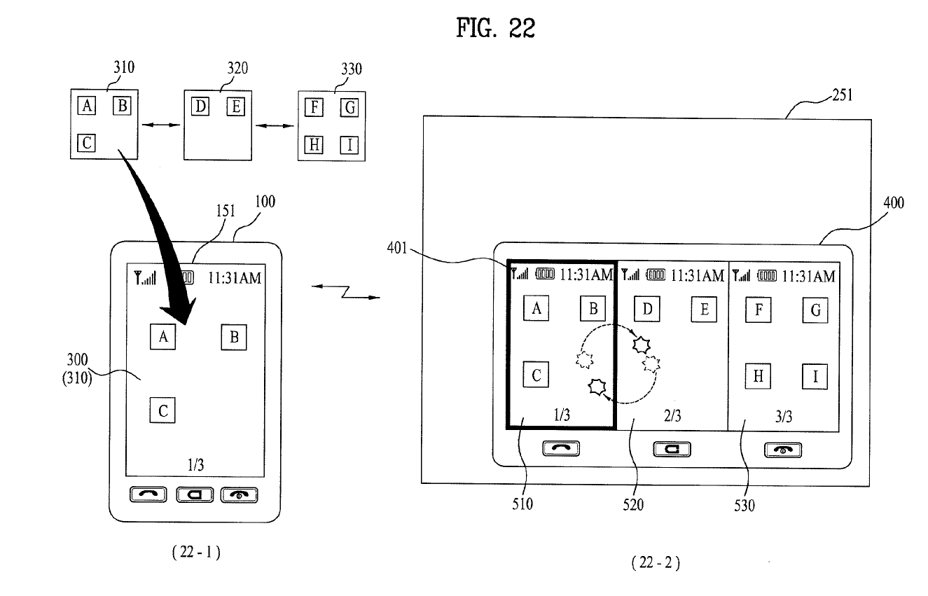

The following description describes a method of changing a switching order of home screen images for the mobile terminal 100 using the subimages displayed on the second display unit 251 of the display device 200 with reference to FIGS. 22 to 25.

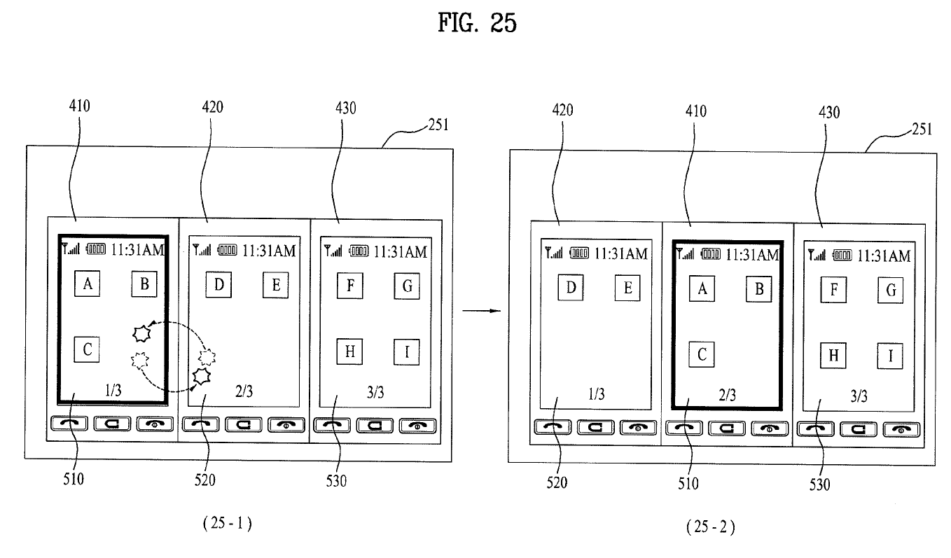

In particular, FIGS. 22 to 24 are diagrams of screen configurations of the mobile terminal and the display unit of the display device according to an embodiment of the present invention. Further, FIG. 25 is a diagram of screen configurations of the display unit of the display device according to an embodiment of the present invention.

As mentioned in the foregoing description, when a prescribed touch gesture (e.g., a touch & drag in one direction) is performed on the mobile terminal 100, one of the first to third home screen images 310, 320 and 330 can be determined as the output home screen image according to mutual order among the first to third home screen images 310, 320 and 330. The following description assumes that the output home screen image is determined in order of ‘first home screen image 310→second home screen image 320→third home screen image 330 each time a prescribed touch gesture is performed in one direction.

Referring to FIG. 22(22-1), the first home screen image 310 becomes the output home screen image and is displayed on the first display unit 151 of the mobile terminal 100. Referring to FIG. 22(22-1), the first to third subimages 510, 520 and 530 respectively corresponding to the first to third home screen images 310, 320 and 330 are displayed as the second screen image 500 on the second display unit 251 of the display device 200. Also, to indicate that the first home screen image 310 is the output home screen image in the mobile terminal 100, the first screen image frame 401 can be displayed on the first subimage 510 of the second display unit 251.

In addition, a user command for changing the order of the first and second home screen images for the mobile terminal 100 can be input via the second user input unit 230 of the display device 200. For instance, referring to FIG. 22(22-2), the user command can be input by simultaneously touching the first and second subimages 510 and 520 of the second display unit 251 and then dragging them clockwise or counterclockwise by about 180 degrees.

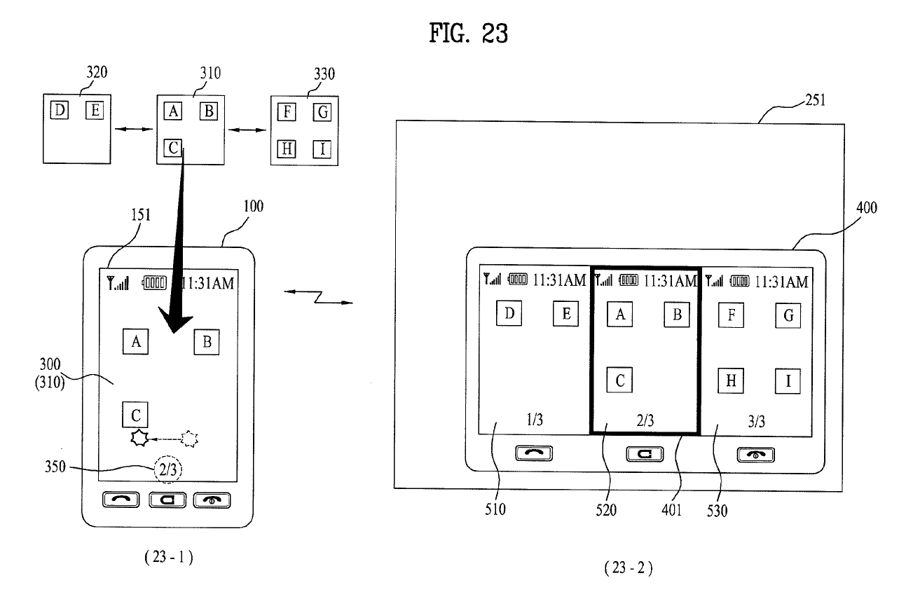

If so, the second controller 280 of the display device 200 transmits a control signal, which indicates that the user command for changing the order of the first and second home screen images has been input, to the mobile terminal 100. Then, in response to the control signal, and referring to FIG. 23(23-1), the first controller 180 of the mobile terminal 100 controls the order of the first and second home screen images 310 and 320 to be switched. In particular, the order of the home screen images is changed in order of the second home screen image 320→the first home screen image 310→the third home screen image 330.

Despite continuously displaying the first home screen image 310 as the first screen image 330, the first controller 180 of the mobile terminal 100 can control the page indicator 350 of the first screen image 300 to be changed into ‘⅔’ from ‘⅓’ according to the changed order of the home screen images. The first controller 180 of the mobile terminal 100 can also control the information on the first screen image, which includes the information on the first to third home screen images according to the changed order, to be provided to the display device 200.

If so, the second controller 280 of the display device 200 receives the information on the first screen image and controls the first to third subimages 510, 520 and 530 to be displayed on the second display unit 251 to correspond to the first to third home screen images according to the changed order (see FIG. 23(23-2)). In particular, the subimages are displayed on the monitor window 400 of the second display unit 251 in order of the second subimage 520→the first subimage 510→the third subimage 530.

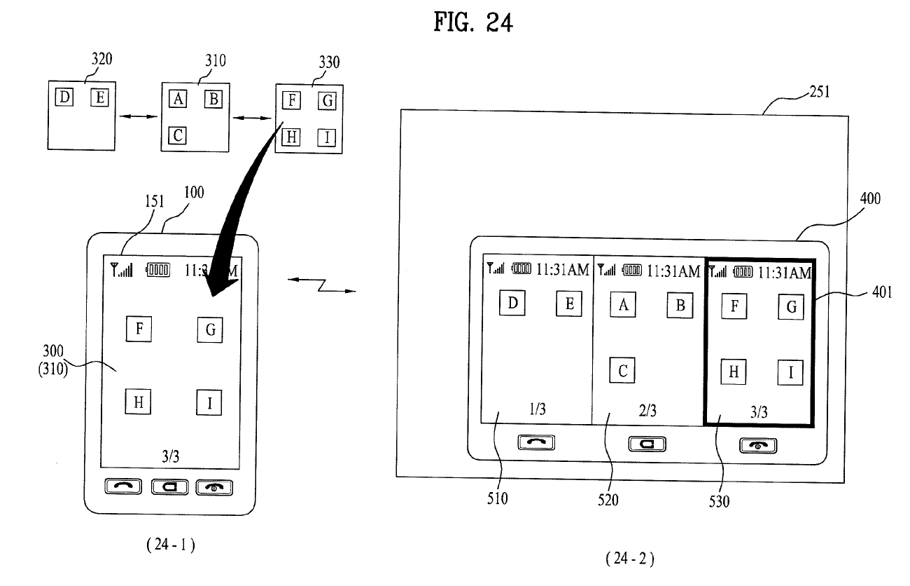

Afterwards, a prescribed touch gesture (e.g., a touch & drag in one direction) can be performed on the first display unit 151 of the mobile terminal 100. If so, referring to FIG. 24(24-1), the first controller 180 of the mobile terminal 100 controls the third home screen image 330 to become the output home screen image instead of the first home screen image 310 according to the changed order of the home screen images and controls the output home screen image to be displayed as the first screen image 300 on the first display unit 151.

Referring to FIG. 24(24-2), the second controller 280 of the display device 200 controls the first screen image frame 401 to be displayed on the third subimage 530 corresponding to the third home screen image 330 that has newly become the output home screen image. Referring to FIG. 25, although the subimages 510, 520 and 530 of the second display unit 251 are displayed on the monitor windows, i.e., the first to third monitor windows 410, 420 and 430, respectively, the order of the first to third home screen images can be changed using the subimages.

For instance, referring to FIG. 25(25-1), the first monitor window 410 (or the first subimage 510) and the second monitor window 420 (or the second subimage 520) are simultaneously touched and dragged by about 180 degrees clockwise or counterclockwise. Thus, the order of the home screens for the mobile terminal 100 can be changed as mentioned in the foregoing description. Referring to FIG. 25(25-2), the order of the first monitor windows 410, 420 and 430 displayed on the second display unit 251 can be changed according to the changed order of the home screens.

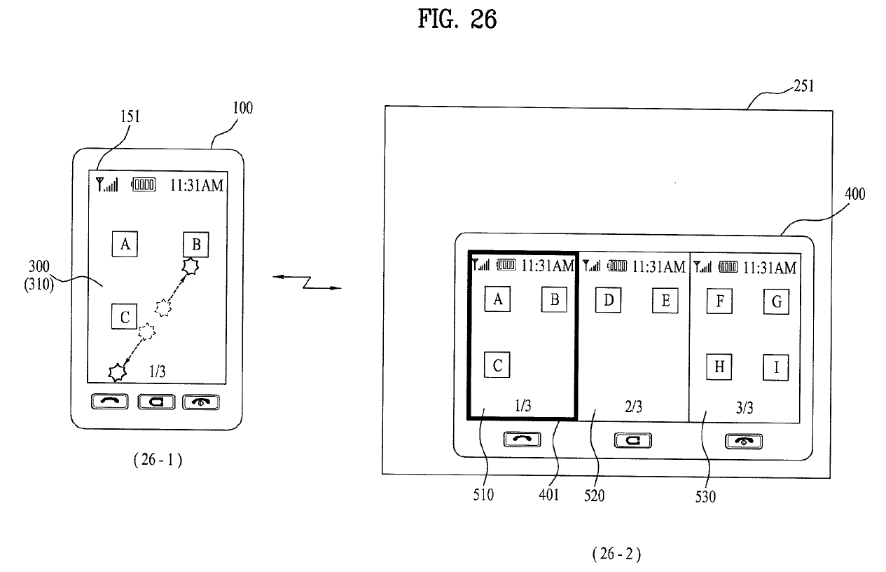

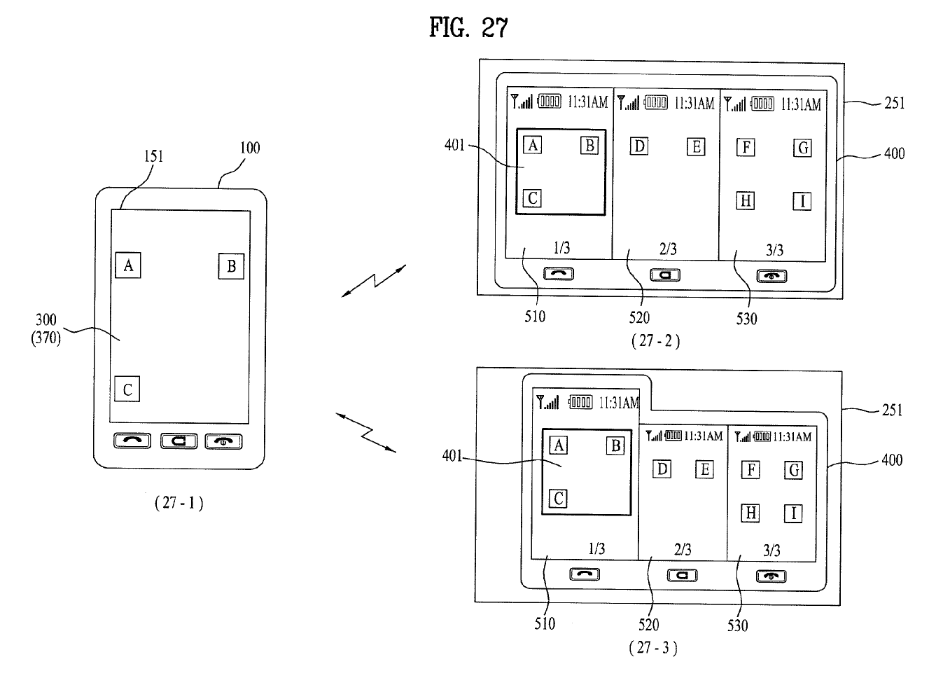

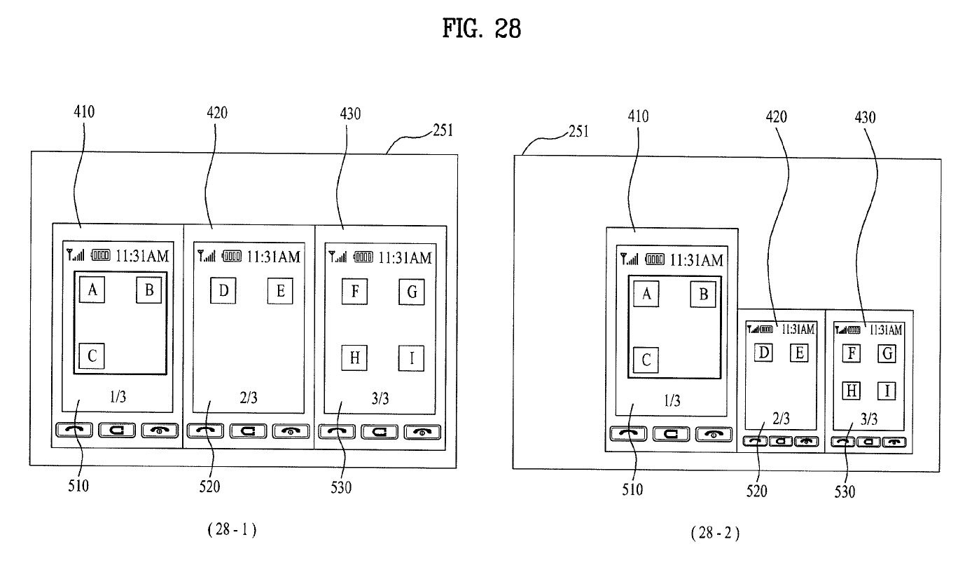

The following description describes a change of the second screen image 500 of the second display unit 251 of the display device 200 when the first screen image 300 is zoomed in on the first display unit 151 of the mobile terminal 100 with reference to FIGS. 26 to 28. In particular, FIGS. 26 and 27 are diagrams of screen configurations of the mobile terminal and the display unit of the display device and FIG. 28 is a diagram of screen configurations of the display unit of the display device according to an embodiment of the present invention.

Referring to FIG. 26(26-1), the first screen image 300 is displayed in a manner that the first home screen image 310 becomes the output home screen image in the first display unit 151 of the mobile terminal 100. Referring to FIG. 26(26-1), the first to third subimages 510, 520 and 530 respectively corresponding to the first to third home screen images 310, 320 and 330 are displayed as the second screen image 500 on the second display unit 251 of the display device 200.

A user command for enabling the first screen image 300 displayed on the first display unit 151 to be zoomed in can also be input via the first user input unit 130 of the mobile terminal 100. For instance, the user command can be input in a following manner. First of all, when the first display unit 151 includes a touchscreen, two points of the first screen image 300 are simultaneously touched on the touchscreen and are then dragged in directions to get more distance from each other.

If so, referring to FIG. 27(27-1), the first controller 180 of the mobile terminal 100 controls the first screen image 300 to be zoomed in on the first display unit 151. Subsequently, the first controller 180 100 transmits the information on the zoomed-in first screen image 300 to the display device 200. If so, the second controller 280 of the display device 200 receives the information on the zoomed-in first screen image 300.

Referring to FIG. 27(27-2), the second controller 280 of the display device 200 controls the first to third subimages 510, 520 and 530 to be enlarged according to the extent of the zoom-in. As the first to third subimages 510, 520 and 530 are enlarged, the monitor window 400 can be enlarged in proportion to the enlarged subimages. Further, the second controller 280 of the display device 200 can control the first screen image frame 401 to be displayed on the first subimage 510 corresponding to the first home screen image 310, which is the first screen image 300.

Alternatively, referring to FIG. 27(27-3), the second controller 280 of the display device 200 can control only the first subimage 510, which corresponds to the first home screen image 310 (i.e., the first screen image 300), among the first to third subimages 510, 520 and 530 to be enlarged. As sizes of the second and third subimages 520 and 530 are maintained, if the first subimage 510 is enlarged only, a shape of the monitor window 400 can be deformed as shown in FIG. 27(27-2).

As mentioned in the foregoing description, the first screen image frame 401 can be displayed on the first subimage 510 corresponding to the first home screen image 310, which is the first screen image 300, to correspond to the zoomed-in first screen image 300.

Referring to FIG. 28, even if the first to third subimages 510, 520 and 530 of the second display unit 251 are displayed on the first to third monitor windows 410, 420 and 430, respectively, the same control as mentioned in the above description is applicable. In particular, when the first screen image is zoomed in, referring to FIG. 28(28-1), all of the first to third subimages 510, 520 and 530 can be enlarged. Alternatively, when the first screen image is zoomed in, referring to FIG. 28(28-2), the first subimage 510 can be enlarged only.

FIG. 28(28-1) corresponds to FIG. 27(27-2) and FIG. 28(28-2) can correspond to FIG. 27(27-3). This is apparent to those skilled in the art from the foregoing description and its details shall be omitted from the following description for clarity of this disclosure.

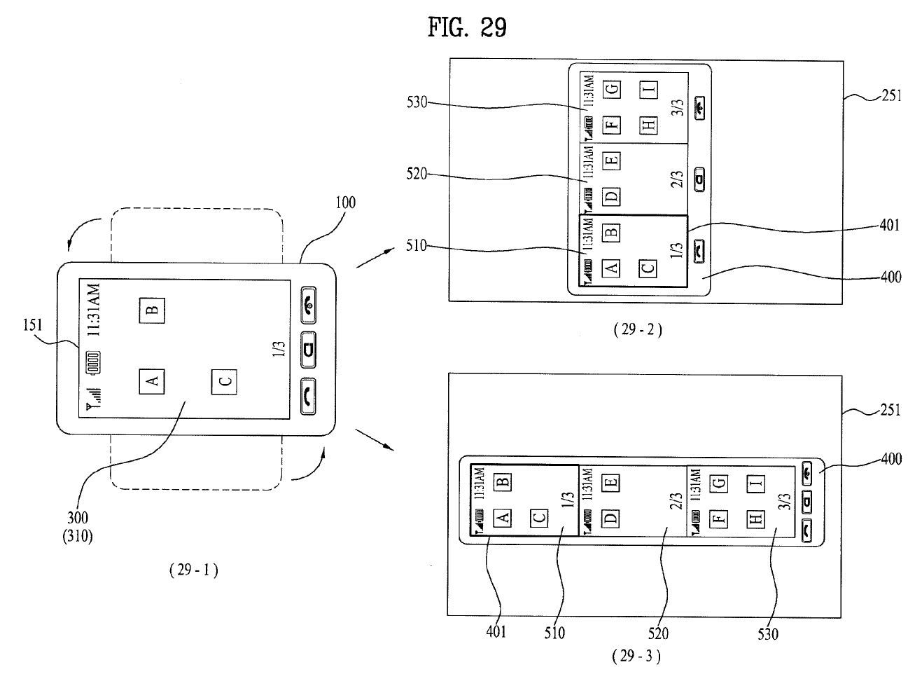

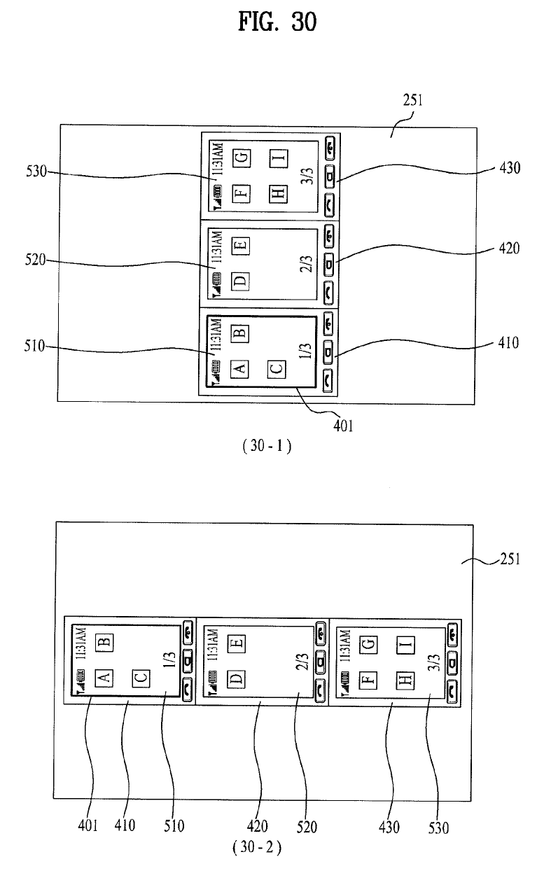

In the following description, a change of the second screen image 500 of the second display unit 251 of the display device 200 when an aligned direction of the housing of the mobile terminal 100 is changed is explained with reference to FIGS. 29 and 30.

In particular, FIG. 29 is a diagram of screen configurations of the mobile terminal and the display unit of the display device and FIG. 30 is a diagram of screen configurations of the display unit of the display device according to an embodiment of the present invention.

Referring to FIG. 29(29-1), a user can change an aligned direction of the housing of the mobile terminal 100 by turning the housing of the mobile terminal 100 counterclockwise to align the mobile terminal 100 in a horizontal direction. If so, the first controller 180 of the mobile terminal 100 detects the changed alignment direction via the first sensing unit 140. The first controller 180 then provides the detected alignment direction to the display device 200.

Referring to FIG. 29(29-2), the second controller 280 of the display device 200 controls the monitor window 400 to be arranged by being rotated counterclockwise according to the changed alignment direction. In particular, the first to third subimages 510, 520 and 530 are arranged in vertically parallel with each other in the monitor window 400.

Alternatively, referring to FIG. 29(29-3), the second controller 280 controls the first to third subimages 510, 520 and 530 within the monitor window 400 to be arranged by being rotated at original positions counterclockwise along the changed alignment direction without rotating the monitor window 400. In particular, the first to third subimages 510, 520 and 530 are arranged in horizontally parallel with each other within the monitor window 400.

Referring to FIG. 30, even if the first to third subimages 510, 520 and 530 of the second display unit 251 are displayed on the first to third monitor windows 410, 420 and 430, respectively, the same control as mentioned in the above description is applicable. In particular, when the aligned direction of the housing of the mobile terminal 100 is changed, referring to FIG. 30(30-1), the first to third monitor windows can be arranged in a manner of being entirely rotated according to the changed alignment direction. Alternatively, when the aligned direction of the housing of the mobile terminal 100 is changed, referring to FIG. 30(30-2), the first to third monitor windows can be arranged in a manner of being respectively rotated at their original positions according to the changed alignment direction.

Meanwhile, FIG. 30(30-1) corresponds to FIG. 29(29-2) and FIG. 30(30-2) can correspond to FIG. 29(29-3). This is apparent to those skilled in the art from the foregoing description and its details shall be omitted from the following description for clarity of this disclosure.

Accordingly, the present invention provides the following advantages. First, according to at least one of embodiments of the present invention, when data communications are performed between the mobile terminal and the display device, information on the data communications between the mobile terminal and the display device can be displayed on the mobile terminal and the display device in further consideration of terminal user's convenience.

In particular, when a mobile terminal, which selects one of at least two home screen images and then displays the selected home screen image as an output home screen image, is connected to a display device, at least one of the at least two home screen images can be simultaneously displayed on the connected display device. Therefore, a user can easily adjust the configuration and arrangement of objects of the home screen images by viewing the configuration and arrangement on the display device at a glance.

As mentioned in the foregoing description, the present invention is applicable to such a mobile terminal as a mobile phone, a smart phone, a notebook computer e.g., a laptop), a digital broadcast terminal, a PDA (personal digital assistants), a PMP (portable multimedia player), a navigation system and the like and/or such a display device as a notebook computer (e.g., laptop), a tablet computer, a desktop computer, a television set (e.g., a digital TV set, a smart TV set, etc.) and the like.

It will be apparent to those skilled in the art that various modifications and variations can be specified into other forms without departing from the spirit or scope of the inventions.

For instance, the above-described methods can be implemented in a program recorded medium as computer-readable codes. The computer-readable media include all kinds of recording devices in which data readable by a computer system are stored. The computer-readable media include ROM, RAM, CD-ROM, magnetic tapes, floppy discs, optical data storage devices, and the like for example and also include transmission via Internet. The computer can include the controller 180 of the terminal.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

1. A mobile terminal, comprising:
a first display unit configured to display at least one of a first home screen image and a second home screen image as an output home screen image;
an interface unit configured to be connected to an external display device, the external display device configured to be controlled by a microprocessor and having a second display unit; and
a controller configured to generate a monitor window including a copy of the output home screen image displayed on the first display unit of the mobile terminal and to control the external display device to simultaneously display the generated monitor window on the second display unit of the external display device.

2. The mobile terminal of claim 1, wherein the controller is further configured to transmit information to the external display device corresponding to the displayed first and second home screen images, and to control the external display device to simultaneously display the first and second home screen images in the monitor window on the external display device.

3. The mobile terminal of claim 2, wherein the controller is further configured to control the external display device to display each of the first and second home screen images in separate monitor windows on the second display unit.

4. The mobile terminal of claim 2, wherein the controller is further configured to control the external display device to highlight a respective one of the first and second home screen images displayed in the monitor window that corresponds to the one of the first and second home screen images displayed as the output home screen image on the mobile terminal.

5. The mobile terminal of claim 1, wherein each of the first and second home screen images includes at least one object, and
wherein if one object is selected and deleted from the first home screen image or is shifted to the second home screen image on the second display unit, the controller is further configured to control the selected object to be deleted from the first home screen image or to be shifted to the second home screen image on the first display unit of the mobile terminal.

6. The mobile terminal of claim 2, wherein if one of the first and second home screen images displayed in the monitor window on the second display unit of the external display device is selected, the controller is further configured to display the selected one of the first and second home screen images on the first display unit of the mobile terminal.

7. The mobile terminal of claim 2, wherein the controller is further configured to receive an input signal requesting the first and second home screen images to be sequentially displayed as the output home screen image on the first display unit in a prescribed display order, and
wherein if an arrangement of the first and second home screen images displayed in the monitor window on the second display unit is adjusted, the controller is further configured control the first display unit to display the first and second home screen images as the output home screen image in a display order that matches the adjusted arrangement.

8. The mobile terminal of claim 1, wherein if one of the first and second home screen images displayed as the output home screen image is zoomed in or zoomed out on the first display unit, the controller is further configured to control the second display unit of the external display device to zoom in or zoom out the corresponding first or second home screen image displayed in the monitor window of the external display device.

9. The mobile terminal of claim 4, wherein at least one of the first and second home screen images includes at least one object, and
wherein the controller is further configured to receive a selection signal indicating a selection of an object on said one of the first and second home screen images displayed as the home screen image on the first display unit, to execute a corresponding application and display an image of the executed application on the first display unit, and to control the second display unit of the external display device to display the same application image on the monitor window in the second display unit.

10. (canceled)

11. A display device configured to be controlled by a microprocessor, comprising:
an interface unit configured to be connected to a mobile terminal having a first display unit configured to display at least one of a first home screen image and a second home screen image as an output home screen image on the first display unit;
a second display unit; and
a controller configured to generate a monitor window including a copy of the output home screen image displayed on the first display unit and to control the second display unit to simultaneously display the generated monitor window on the second display unit.

12. The display device of claim 11, wherein the controller is further configured to receive information from the mobile terminal corresponding to the displayed first and second home screen images, and to control the second display unit to simultaneously display the first and second home screen images in the monitor window on the second display unit.

13. The display device of claim 12, wherein the controller is further configured to control the second display unit to display each of the first and second home screen images in separate monitor windows on the second display unit.

14. The display device of claim 12, wherein the controller is further configured to control the second display unit to highlight a respective one of the first and second home screen images displayed in the monitor window that corresponds to the one of the first and second home screen images displayed as the output home screen image on the mobile terminal.

15. The display device of claim 11, wherein each of the first and second home screen images includes at least one object, and
wherein if one object is selected and deleted from the first home screen image or is shifted to the second home screen image on the second display unit, the controller is further configured to control the selected object to be deleted from the first home screen image or to be shifted to the second home screen image on the first display unit of the mobile terminal.

16. The display device of claim 12, wherein if one of the first and second home screen images displayed in the monitor window on the second display unit is selected, the controller is further configured to display the selected one of the first and second home screen images on the first display unit of the mobile terminal.

17. The display device of claim 12, wherein the controller is further configured to receive an input signal requesting the first and second home screen images to be sequentially displayed as the output home screen image on the first display unit in a prescribed display order, and
wherein if an arrangement of the first and second home screen images displayed in the monitor window on the second display unit is adjusted, the controller is further configured control the first display unit to display the first and second home screen images as the output home screen image in a display order that matches the adjusted arrangement.

18. The display device of claim 11, wherein if one of the first and second home screen images displayed as the output home screen image is zoomed in or zoomed out on the first display unit, the controller is further configured to control the second display unit to zoom in or zoom out the corresponding first or second home screen image displayed in the monitor window.

19. The display device of claim 14, wherein at least one of the first and second home screen images includes at least one object, and
wherein the controller is further configured to receive a selection signal indicating a selection of an object on said one of the first and second home screen images displayed as the home screen image on the first display unit, to execute a corresponding application and display an image of the executed application on the first display unit, and to control the second display unit to display the same application image on the monitor window in the second display unit.

20. The display device of claim 11, wherein when an object included in said on one of the first and second home screen images is selected to execute a function, the controller is further configured to execute the function on the first display unit of the mobile terminal and the same function on the second display unit.

21. A method of controlling a mobile terminal, the method comprising:
displaying, on a first display unit of the mobile terminal, at least one of a first home screen image and a second home screen image as an output home screen image;
connecting, via an interface unit on the mobile terminal, an external display device, the external display device configured to be controlled by a microprocessor and having a second display unit; and
controlling, via the controller, the external computer display device to simultaneously display a monitor window on the second display unit of the external computer display device that includes a copy of the output home screen image displayed on the first display unit of the mobile terminal.

22. (canceled)
